(19) United States
(12) Patent Application Publication
(10) Pub. No.: US 2013/0024105 A1
(43) Pub. Date: Jan. 24, 2013

(54) LOCATION-BASED EMPLOYMENT SEARCH USING EMPLOYER AND CANDIDATE MOBILE COMMUNICATION DEVICES

(71) Applicant: Mark A. Thomas, San Francisco, CA (US)

(72) Inventor: Mark A. Thomas, San Francisco, CA (US)

(73) Assignee: INTUIT INC., Mountain View, CA (US)

(21) Appl. No.: 13/284,694

(22) Filed: Oct. 28, 2011

Related U.S. Application Data
(60) Provisional application No. 61/509,437, filed on Jul. 19, 2011.

(51) Int. Cl. G06Q 10/06; G01C 21/00

(52) U.S. Cl. 701/410; 705/321

(57) ABSTRACT

Computer-implemented methods, systems and computer program products or applications for location-based, mobile-to-mobile connection of employers and candidates, while providing employers and candidates the ability to search for matching profiles and coordinate with each other in real time while utilizing their mobile communication devices to meet each other immediately or at a later time. Search results also indicate a distance between current locations of employer and candidates as determined from location data of their mobile communication devices and/or a distance between a candidate's residence and job location. Such location data enables employers and candidates to assess the ability to meet now or at a later time given their current locations and the ability of a candidate to travel to a job location given the candidate's residence location.

### CROSS-REFERENCE TO RELATED APPLICATION

The present application claims the benefit under 35 U.S.C. §119 of U.S. Provisional Patent Application Ser. No. 61/509,437, filed Jul. 19, 2011, the entire contents of which are incorporated by reference into the present application.

### BACKGROUND

The invention relates to connecting employers with qualified job seekers. It can be very difficult, from both an employer's and job seeker's perspective, to identify and fill an open position with a good employer-employee match. Traditionally, job seekers scan want ads, send letters to employers, call employers, or even visit employer offices in person to inquire whether the employer has any open positions. This approach has a number of obvious shortcomings including, for example, limited effectiveness, lack of personal communication or contact between employers and job seekers, job seekers not knowing whether the employer has a need for people with their backgrounds and experience, employers receiving inquiries from job seekers who are not qualified or who are not a good match for the employer, and job seekers often required to wait until they hear back from an employer, if they ever do. This process can be frustrating and waste valuable time and resources. These shortcomings may be even more problematic when employers have an immediate need for assistance since this traditional process may take days, weeks or months before qualified job seekers learn about these opportunities, employers interview candidates who are good matches, and candidates are actually hired.

On-line employment resources such as monster.com have enhanced the way in which employers and job seekers express their employment needs and perform employment searches. When using monster.com, for example, employers post descriptions of their open positions, which can then be searched by users who access the website. If a user is interested in a position, the user can contact a person identified in the description or apply on-line by completing a form provided by the employer. Thus, these types of websites are still based on the traditional process summarized above, but with the convenience that employers can post job openings on-line, and candidates can review on-line job openings and submit a resume using their computer.

While websites such as monster.com have provided an improved level of convenience to employers and job seekers relative to other traditional methods, known employment resources nevertheless suffer from a number of shortcomings and inconveniences associated with the time consuming process of soliciting resumes or posting on-line listings, reviewing resumes mailed or submitted on-line by candidates, deciding which candidates are good matches after reviewing resumes, contacting those candidates, scheduling interviews (assuming the candidate is still available and interested in the position since the candidate may have accepted another position), conducting the interview, and going through the hiring process. This process can take days, weeks, months or longer. Further, this process has limited employer-candidate interaction, on-line submissions can be impersonal, and employers and candidates may not meet in person, or if they do, meetings may not occur until well after a candidate expresses interest in a job opening.

### SUMMARY

Certain embodiments are directed to computer-implemented, location-based methods for matching and connecting an employer and a candidate employee through the use of their respective mobile communication devices. Certain embodiments are directed to a candidate searching for employment opportunities and inviting an employer to meet or scheduling a meeting or interview with the employer via mobile communication device communications, while the employer and candidate are provided with real-time location or distance data such as a distance between current locations of the employer and candidate (e.g., as determined by location data of their mobile communication devices) and/or a distance between a candidate's residence and job location, thus allowing employers and candidates. This location data enables employers and candidates to assess each other's locations and determine when and where to meet (even meeting in real time or immediately on the same day), and to assess whether a job location would be suitable for a candidate given where the candidate lives. Thus, embodiments provide for more effective, timely and efficient by matching employers with candidates, with the added convenience that all of this can be done using their mobile communication devices at any time from any location.

One embodiment comprises displaying, on a first mobile communication device of the candidate employee, data of a first employment opportunity offered by a first employer, together with location data such as one or both of a distance between a current location of the first mobile communication device and a current location of a second mobile communication device of the first employer and a distance between an employment opportunity and a candidate's residence. The method further comprises receiving a first input entered by the candidate employee into the first mobile communication device and indicating whether the candidate employee wants to meet with the first employer regarding the first employment opportunity, and sending a first electronic message from the first mobile communication device to the second mobile communication device based at least in part upon the first input.

Other embodiments are directed to an employer searching for qualified candidates or candidates who match certain criteria and scheduling a meeting or interview with the candidate via mobile communication device communications, while the employer and candidate are provided with real-time location or distance data such as one or both of a distance between current locations of the employer and candidate (e.g., as determined by location data of their mobile communication devices) and a distance between a candidate's residence and job location. This location data enables employers and candidates to assess each other's locations to determine when and where to meet (e.g., in real time or immediately), and to assess whether a job location would be suitable for a candidate given where the candidate lives, thereby matching employers with candidates with greater effectiveness, efficiency and timeliness.

One embodiment involves comprises displaying, on a first mobile communication device of the employer, data of a first candidate employee (such as qualifications, experience, etc.) for an employment opportunity offered by the employer, together with location data such as a distance between a current location of the first mobile communication device and a current location of a second mobile communication device of the candidate employee. The method further comprises receiving a first input entered by the employer into the first mobile communication device and indicating whether the employer wants to meet with the first candidate employee regarding the employment opportunity. The first electronic message is sent from the employer's first mobile communication device to the second mobile communication device of the candidate employee based at least in part upon the first input.

Yet other embodiments are directed to managing profiles and performing searches for employers and candidates and providing search results that match a request or satisfy certain criteria. For this purpose, employers and candidates may download an application to their mobile communication devices that is operable to communicate with an intermediate computer and to prepare their respective profiles, e.g., experience, qualifications and residence zip code for candidates, and job title and desired qualifications or experience for employers. These profiles are transmitted to the intermediate computer and stored in a database. When an employer requests search results for candidates or expresses an interest in a particular candidate, or a candidate request search results for employment opportunities or expresses an interest in a particular employer, these initial search communications are directed through the intermediate computer until the employer and/or candidate are provided with each other's personal contact information so that they may contact each other directly (by phone, e-mail or text) without being directed through the intermediate computer.

For example, according to one embodiment, the intermediate computer receives one or more employer profiles comprising respective employment opportunities and from respective mobile communication devices of respective employers. A candidate employee launches the application, enters search criteria (e.g. job location or zip code), enters profile information (e.g., experience and qualifications), and sends the search criteria and profile as a first electronic message to the intermediate computer. The intermediate computer, e.g., utilizing a profile or comparison engine, compares the received candidate employee profile and criteria with the stored employer profiles (e.g., for matching or substantially matching job titles, experience, etc.), selects one or more employer profiles based at least in part upon the search criteria and comparison, and sends a second electronic message back to the candidate's first mobile communication device with the selected employer profile with the employer's employment opportunity. After the candidate has reviewed the search results, the intermediate computer receives a further electronic message from the candidate's first mobile communication device indicating whether the candidate employee wants to meet (e.g., now, later, never or not interested) with the selected employer regarding the employment opportunity offered by the selected employer. The intermediate computer then sends an electronic message to a second mobile communication device of the selected employer notifying the selected employer of the candidate employee's interest (if the candidate is interested). The intermediate computer later receives an electronic message from the second mobile communication device indicating whether the selected employer is also interested in or wants to meet with the candidate employee, and if so, the intermediate computer sends an electronic message back to the candidate's first mobile communication device together with the employer's contact information (e.g., phone number or e-mail address) notifying the candidate employee of the employer's interest. The employee may then contact the employer directly by phone, text or e-mail with the employer's contact information provided to the candidate. A similar sequence applies to a search initiated by an employer for candidates to fill a position.

Other embodiments are directed to computer program products or mobile applications comprising a non-transitory, computer readable storage medium having a sequence of instructions which, when executed by a mobile communication device, cause the one or more processors to execute a process for location-based mobile-to-mobile matching an employer with a candidate employee. Embodiments may execute on a mobile communication device, and the same application or a separate profile or comparison engine may execute on the intermediate computer.

Further embodiments are directed to systems configured or operable for location-based mobile-to-mobile matching of employers and candidate employees. System embodiments may include a single mobile communication device configured to implement method steps as discussed above, e.g., a mobile communication with an application executing thereon, mobile communication devices of an employer and a candidate, an intermediate computer configured or operable to perform profile comparisons, profile selections, management of location data, and to serve as an interface between an employer's mobile communication device and a candidate employee's mobile communication device. Further system embodiments may involve one or multiple mobile communication devices and the intermediate computer.

In a single or multiple embodiments, in addition to receiving employer and candidate profiles (which include job location and candidate residence data), applications executing in mobile communication devices are configured to determine a current location, e.g., Global Positioning System (GPS) location, and transmit that location data to the intermediate computer, e.g., when the mobile communication device is utilized to initiate a search request or to indicate whether someone is interested or wants to meet or interview. Thus, when an employer or employee views search results, matching profiles are displayed together with location data collected by the intermediate computer. Location data may include distance between mobile communication devices and/or distance between a candidate's residence and job location.

In a single or multiple embodiments, the requesting party (employer or candidate employee) sends an electronic message to invite the other party to meet to discuss an employment opportunity. With embodiments, scheduling or proposing and accepting a proposed meeting and time are performed in real time while each party is utilizing their mobile communication device. According to one embodiment, the requesting party invite the other party to “meet now” or immediately or as soon as possible, in real time while utilizing their mobile communication device. In other embodiments, a meeting or interview is scheduled for a later date or other time. When a requesting party sends an invitation to meet, the requesting party may include their contact information (e.g., phone or e-mail address) so that the receiving party can see their contact information and call or e-mail the requesting party as needed. The receiving party can then respond with his or her contact information.

In the event that a reviewing party is not interested in a search result presented, the reviewing party can select an option such as “not interested” and the database hosted by the intermediate computer is updated to reflect the person or search result that received the “not interested” designation is not presented to the reviewing party in later searches.

In a single or multiple embodiments, when an employer and candidate employee agree upon a location and date or time to meet, electronic messages can be sent to one or both of the employer and candidate with a photograph of the other so that each person knows who to look for, which may be particularly helpful if meeting at a restaurant, coffee shop, or other location with other people. Further, after establishing a meeting location, the application executing on the mobile communication device can generate and display a map showing a route from a current location of a first mobile communication device to the meeting location.

In a single or multiple embodiments, a candidate employee or employer views search results comprising multiple profiles. The interface displayed to an employer may include a name or identity of each candidate employee, and each name or identity can be displayed together with one or multiple types of location or distance data. For example, a name or identity may be displayed together with a distance between a current location of the employer (as determined from location data of the employer's mobile communication device) and current location of the candidate employee (as determined from location data of the candidate's mobile communication device) and/or a distance between a location of a candidate employee's residence and a location of the employment opportunity. All of this information may be presented within a single screen view so that the reviewing party can view the name or identity of a search result together with one or multiple types of related location data.

In a single or multiple embodiments, part of the comparison or processing performed by the profile engine or intermediate computer is determining a current location of an employer and/or candidate employee, and filtering out search results based on the distance between them, e.g., during a search by a candidate employee, an employer identified as a potential search result is excluded due to the current employer location being greater than a pre-determined distance from the current candidate employee location, as determined by locations of their respective mobile communication devices. As another example, during a search by an employer for an employee, a candidate employee identified as a potential search result is excluded due to the candidate employee having a residence location or zip code that is greater than a pre-determined distance from a location or zip code of the employment location, e.g., as determined from location data of employer and candidate employee profiles.

### BRIEF DESCRIPTION OF THE DRAWINGS

The foregoing and other aspects of embodiments are described in further detail with reference to the accompanying drawings, wherein:

FIG. 1 is a flow diagram of one embodiment of a location-based mobile-to-mobile method for connecting an employer and a candidate employee, in which a candidate employee reviews an employer profile and invites the employer to meet to discuss an employment opportunity using respective mobile communication devices;

FIG. 2 is a flow diagram of one embodiment of a location-based mobile-to-mobile method for connecting an employer and a candidate employee, in which an employer reviews a candidate employee profile and invites the candidate employee to meet to discuss an employment opportunity using respective mobile communication devices;

FIG. 3 is a block diagram of a system constructed according to one embodiment operable for location-based, mobile-to-mobile matching of employers and candidates using employer and candidate mobile communication devices;

FIGS. 4A-B generally illustrate examples of how data how employer and candidate employee profiles can be structured for use in embodiments;

FIG. 5 is a flow diagram of one embodiment of a location-based, mobile-to-mobile method for connecting an employer and a candidate employee and that may be implemented using system components shown in FIG. 3, and in which the candidate employee prepares a profile and views and selects search results including employer profile data;

FIGS. 6A-M illustrate an embodiment of an interface and screen shot thereof generated by an application executing on a mobile communication device that allows a candidate employee to create a candidate profile, search for and review matching employment opportunities, and invite an employer to meet now or later to discuss a matching employment opportunity;

FIG. 7 is a flow diagram of one embodiment of a location-based, mobile-to-mobile method for connecting an employer and a candidate employee in which a candidate requests to meet an employer now or in real time while utilizing respective mobile communication devices;

FIG. 8 is a flow diagram of one embodiment of a location-based, mobile-to-mobile method for connecting an employer and a candidate employee in which a candidate requests to meet an employer at a later date or time while utilizing respective mobile communication devices to schedule or propose the later date or time;

FIG. 9 is a flow diagram illustrating how a candidate can indicate that the candidate is not interested in an employment opportunity and to prevent that employer from being included in subsequent search results presented to the candidate;

FIG. 10 is a flow diagram of one embodiment of a location-based, mobile-to-mobile method for connecting an employer and a candidate employee and that may be implemented using system components shown in FIG. 3, and in which the employer prepares a profile and views and selects search results including candidate employee profile data;

FIGS. 11A-M illustrate one embodiment of an interface and screen shot thereof generated by an application executing on a mobile communication device and allowing an employer to create an employer profile and job, search for and review matching candidate employees, and invite a candidate employee to meet now or later to discuss a matching employment opportunity;

FIG. 12 is a flow diagram of an embodiment of a location-based, mobile-to-mobile method for connecting an employer and a candidate employee in which an employer requests to meet a candidate employee now or in real time while using respective mobile communication devices;

FIG. 13 is a flow diagram of one embodiment of a location-based, mobile-to-mobile method for connecting an employer and a candidate employee in which an employer requests to meet a candidate employee at a later date or time while utilizing respective mobile communication devices to schedule or propose the later date or time;

FIG. 14 is a flow diagram illustrating how an employer can indicate that the candidate is not interested in a candidate employee and to prevent that candidate employee from being included in subsequent search results presented to the employer; and

FIG. 15 is a system diagram of a computing apparatus that may be utilized by various system components.

### DETAILED DESCRIPTION OF ILLUSTRATED EMBODIMENTS

Embodiments are related to location-based, mobile-to-mobile, real-time matching of employers and potential or candidate employees using their respective mobile communication devices. Employers and candidates use their mobile communication devices to enter their profiles (e.g., job description, experience, etc.), which are compared with each other so that employers who want to fill open positions can review search results of qualified candidate profiles on their mobile communication devices and that have already been subjected to a screening or matching analysis, while candidates seeking a position can review search results of employer profiles on their mobile communication devices that have also been subjected to a screening or matching analysis. These search results are displayed together with one or multiple types of location data such as how far away each is from the other and how far away a candidate's residence is from a job location, while also providing the ability to contact and meet each other in real time, e.g., meet each other immediately, all while using only their mobile communication devices.

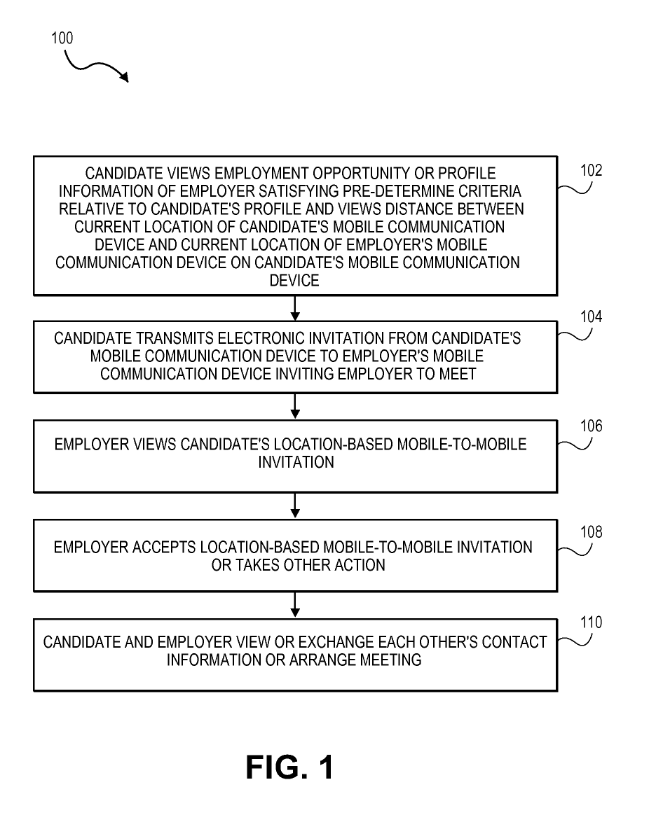

Referring to FIG. 1, one embodiment of an employment matching method 100 involves a candidate employee initiating a search and contacting an employer. At 102, the candidate utilizes a mobile communication device to view employment opportunity or profile information of employer that matches or satisfies pre-determined criteria relative to candidate's profile information while viewing a distance between current location of candidate's mobile communication device and current location of employer's mobile communication device. At 104, after considering their respective locations, the candidate transmits an electronic invitation to meet the employer from the candidate's mobile communication device to the employer's mobile communication device, and at 106, the employer views the candidate's location-based mobile-to-mobile invitation. At 108, the employer accepts location-based mobile-to-mobile invitation or takes other action (e.g., rejects or disregards invitation), and if the employer accepts, at 110, the candidate and employer view or exchange each other's contact information or arrange meeting.

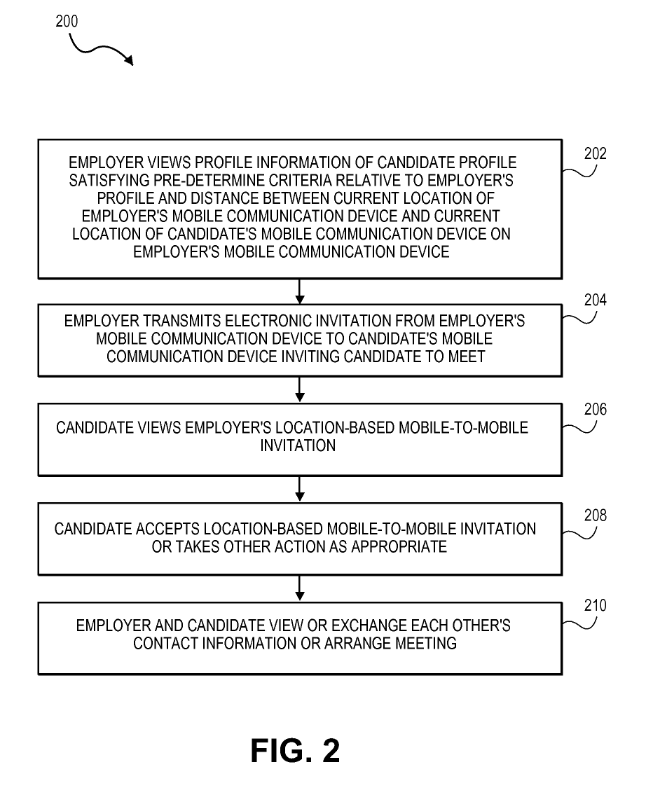

Referring to FIG. 2, one embodiment of an employment matching method 200 involves an employer initiating a search and contacting a candidate employee. At 202, the employer utilizes a mobile communication device to view candidate profiles that match or satisfy pre-determined criteria relative to the employer's profile while viewing a distance between current location of employer's mobile communication device and current location of the candidate's mobile communication device. At 204, after considering their respective locations, the employer transmits an electronic invitation to meet the candidate form the employer's mobile communication device to the candidate's mobile communication device, and at 206, the candidate views the employer's location-based mobile-to-mobile invitation. At 208, the candidate accepts the location-based mobile-to-mobile invitation or takes other action (e.g., rejects or disregards invitation), and if the candidate accepts, at 210, the candidate and employer view or exchange each other's contact information or arrange meeting.

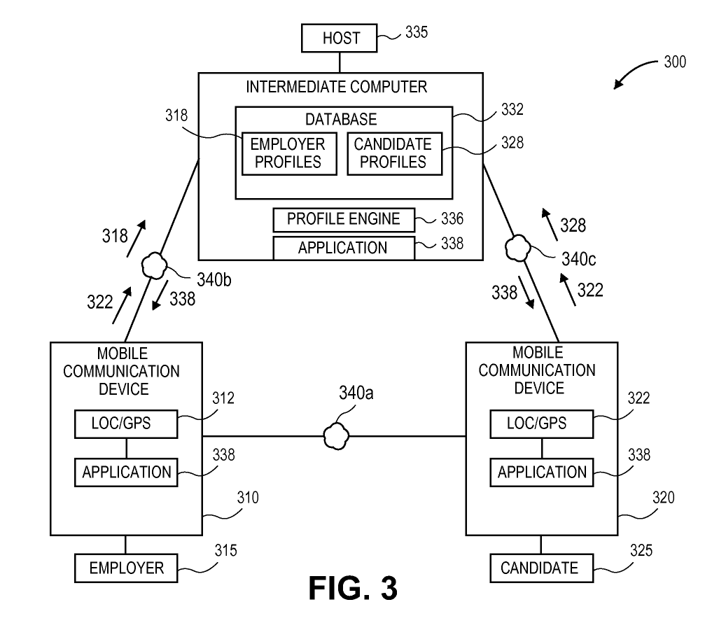

Thus, embodiments simplify and streamline the often arduous process of locating qualified candidates, employment opportunities, and interview scheduling and actual meetings based on location or distance data, thus making employer or candidate search results more meaningful and productive since employers and candidates can meet immediately or at a later time. These capabilities are particularly beneficial to employers and candidates who are on the go or travel and have limited time to meet due to work, travel or social commitments since embodiments account for their current locations so that employers and candidates can take advantage of in-person meetings while each is in the vicinity of the other, and taking advantage of short amounts of available time. Further aspects of embodiments and other embodiments are described in further detail below with reference to FIGS. 3-15.

Referring to FIG. 3, a system 300 constructed according to one embodiment configured or operable for location-based, mobile-to-mobile matching of employers and qualified candidate employees (generally, “candidates”), includes or involves a mobile communication device 310 of an employer 315, a mobile communication device 320 of a candidate employee 325, and an intermediate computer or server 330 of a third party or host 335 (generally, “host”). The mobile communication devices 310, 320 are operable to communicate with each other and with the intermediate computer 330 through respective networks 340a-c (generally, network 340).

Mobile communication devices 310, 320 that may be utilized in embodiments include, but are not limited to, a cellular telephone, a feature phone, a smartphone, a personal digital assistant (PDA) phone, tablet computing/communication devices, and other communication devices capable of communicating with each other and the intermediate computer 330. Employers 315 and candidates 325 may enter data into mobile communicate device 310, 320 using data input components such as a keyboard, display or touch screen, user interface, scroll wheel, voice recognition and/or other suitable data input components.

Each mobile communication device 310, 320 has a location element 312, 322 such as a Global Positioning System (GPS) element (“Loc/GPS” as shown in FIG. 3) that indicates respective current locations of the mobile communication devices 310, 320 which, in turn, indicates a current location of the employer 315 and candidate 325 who are carrying respective mobile communication devices 310, 320. Each mobile communication device 310, 320 also has a location-based employment application 338 (generally, “application”) configured and operable according to embodiments. In the illustrated embodiment, the intermediate computer 330 hosts the application 338, which is downloaded to and executes on mobile communication devices 310, 320, but embodiments are not so limited.

The intermediate computer 330 also hosts a database 332 for storing employer and candidate profiles 318, 328 and current employer and candidate locations 312, 322. In the illustrated embodiment, the intermediate computer 330 also hosts or accesses a profile engine, processor or manager 336 (generally, profile engine) that is operable to receive and store profile and location data, communicate with the mobile communication devices regarding employment search requests, and perform comparisons of employer and candidate profiles in response to search requests. Embodiments may involve the application 338 being executable to perform these processes, but in the illustrated embodiment, FIG. 3 illustrates the application 338 hosted by the intermediate computer 330, downloaded to respective mobile communication device 310, 320, and a separate profile manager 336 that compares profiles and manages database 332, but embodiments are not so limited.

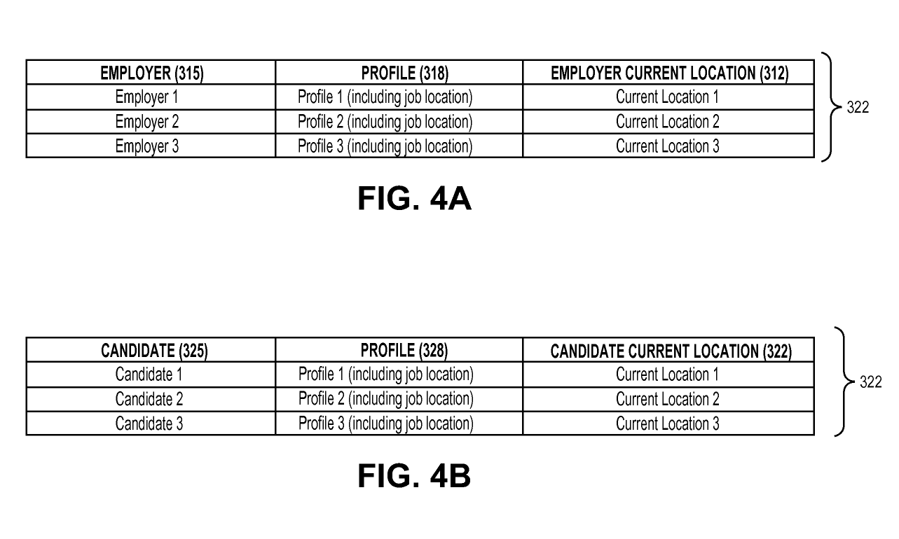

For example, referring to FIGS. 4A-B, the profile engine 336 receives profiles 328 from various candidates 325 and respective current locations 322 of candidates 325 and stores that data in a table or other data structure in database 332, and also receives profiles 318 of various employers 315 and respective current locations 312 and stores that data in a table or other data structure in database 332. For example, as described in further detail below, an employer profile 318 may include data of the employer or employment opportunity such as employer name, employer or job location or zip code, job category, job title, desired qualifications or years of experience, location, duration, pay or salary, etc. A candidate employee profile 328 may include the same or similar types of data so that types of data or categories of employer and employee profiles 318, 328 correspond directly to each other so that they can be compared directly, or are mapped to each other as necessary.

For purposes of communicating with each other and the intermediate computer 330, the mobile communication devices 310,320 are in communication with each other via network 340a, and in communication with the intermediate computer 330 through respective networks 340b-c. (generally, network 340). Each of the networks 340 and other networks discussed herein may be different, or two or more networks may be the same depending on the system configuration and communication device and communication protocols employed.

One or more or all of the networks 340 may be, for example, a cellular network or a wireless network, e.g., WiFi or wireless local area networks that utilize the 802.11 wireless standard, wireless networks available in public places such as a library, a coffee shop, etc., a Global System for Mobile Communications (GSM) network, a code division multiple access (CDMA) network, or a time division multiple access (TDMA) or other suitable wireless or cellular networks capable of wirelessly connecting two computing or communication devices 310, 320 and communicating with the intermediate computer 330. Communications, e.g., communications between mobile communication devices 310, 320 may also involve various protocols or types of data such as voice, text Short Message Service (SMS) messages, Multimedia Message Service (MMS) messages. It should be understood that the communications protocol, form of communications and associated programs employed may depend on the types and configurations of the mobile communication devices 310, 320 and the intermediate computer 330. Accordingly, reference to a network 340 generally and communications between communication devices 310, 320 and with the intermediate computer 330 are not intended to refer to a specific network or communications protocol, and it should be understood that embodiments can be implemented using various networks and combinations thereof and non-voice and/or voice communications.

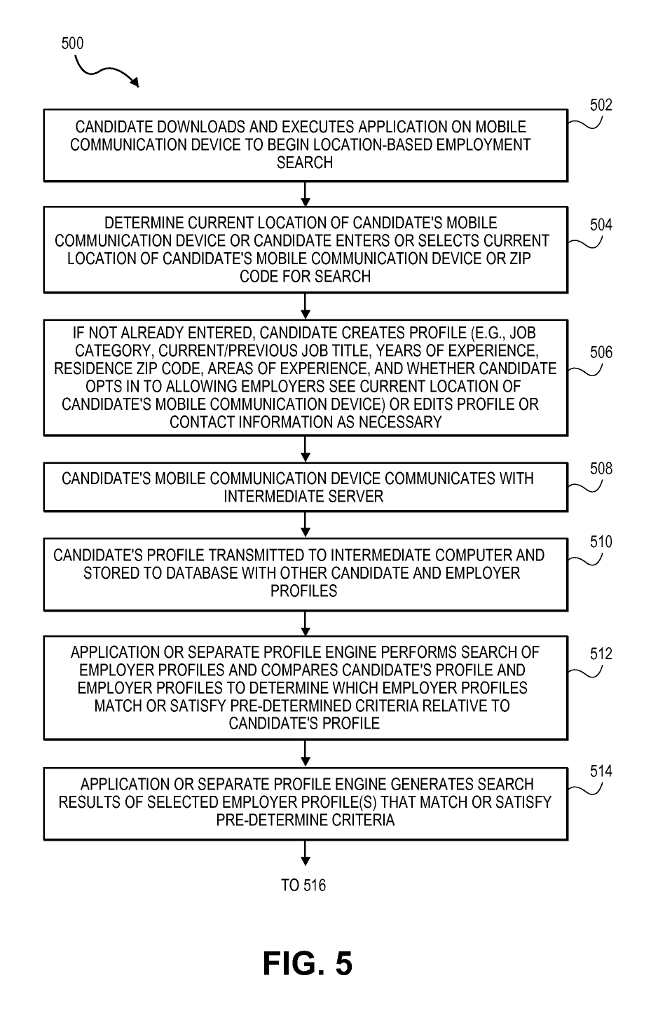

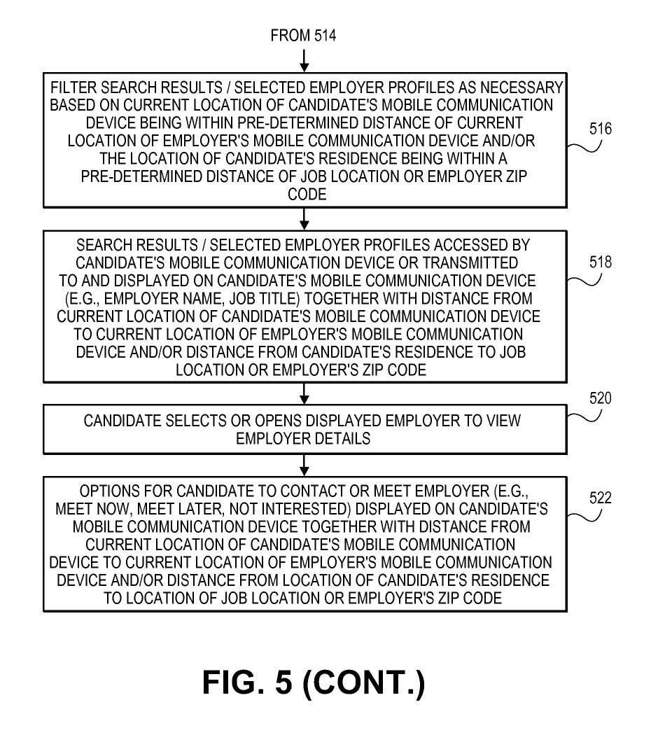

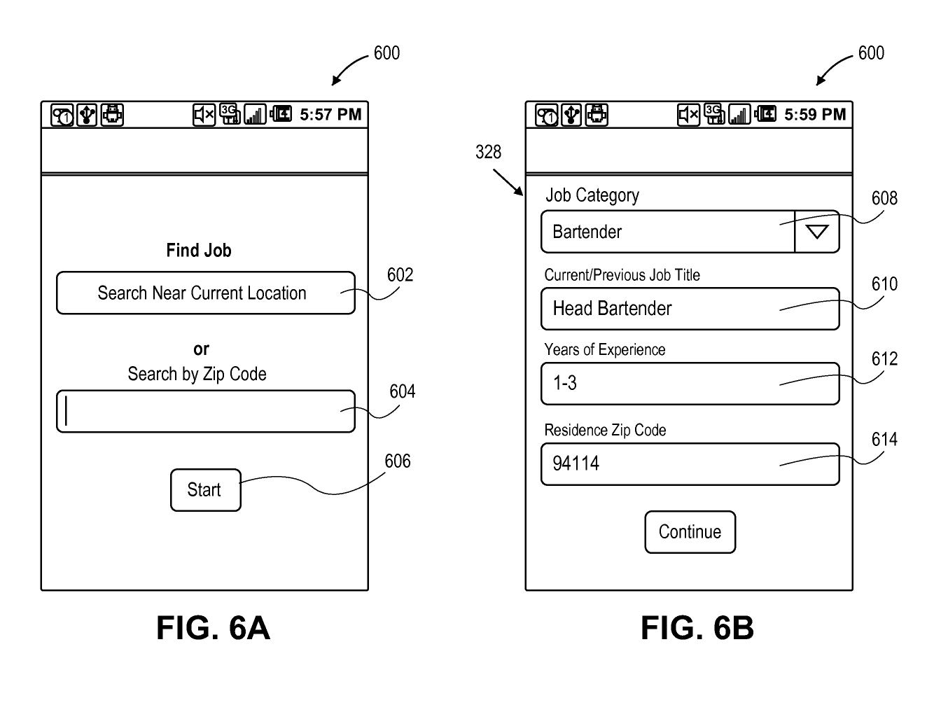

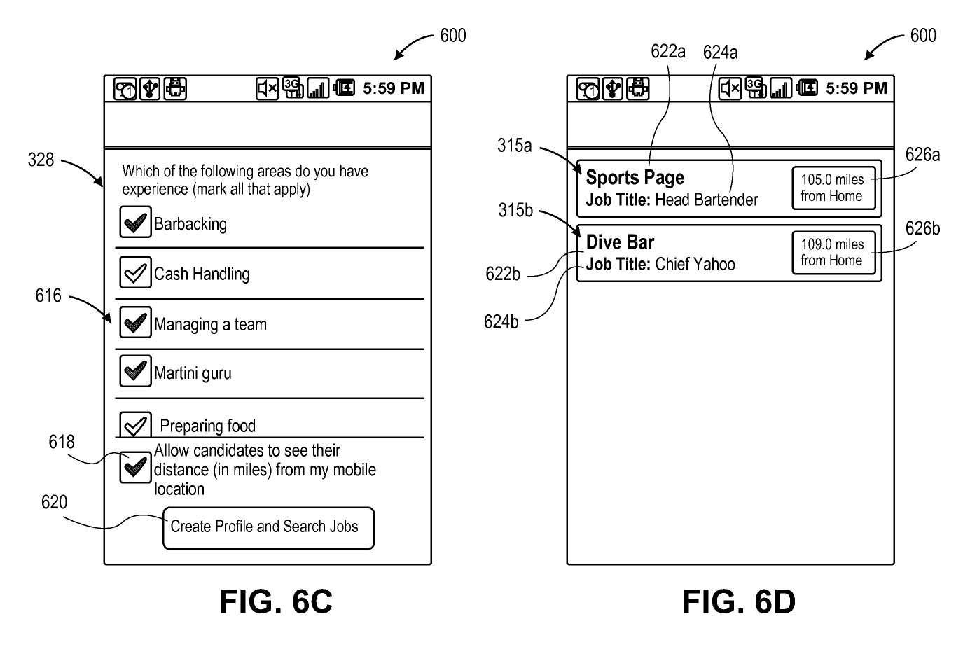

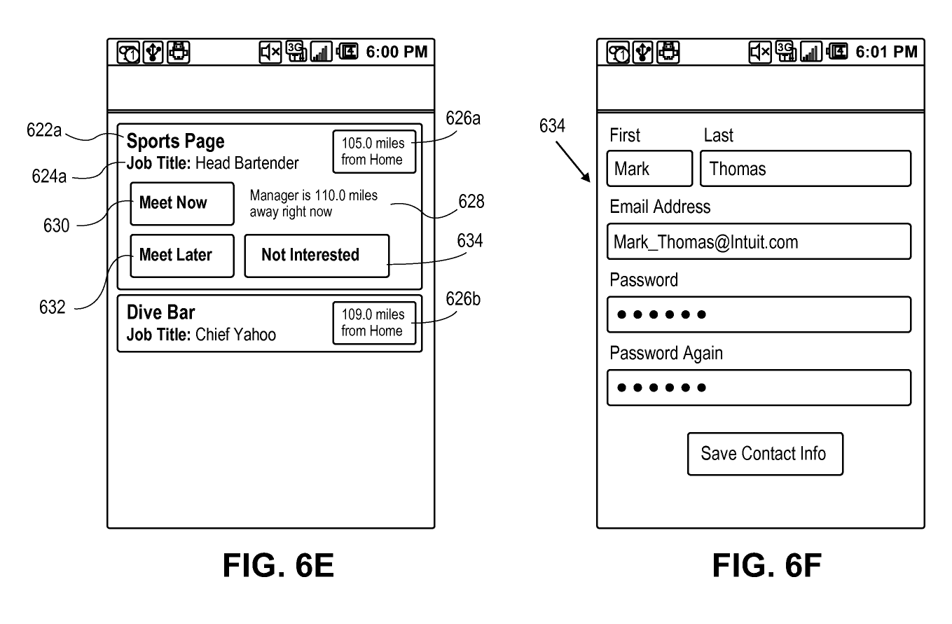

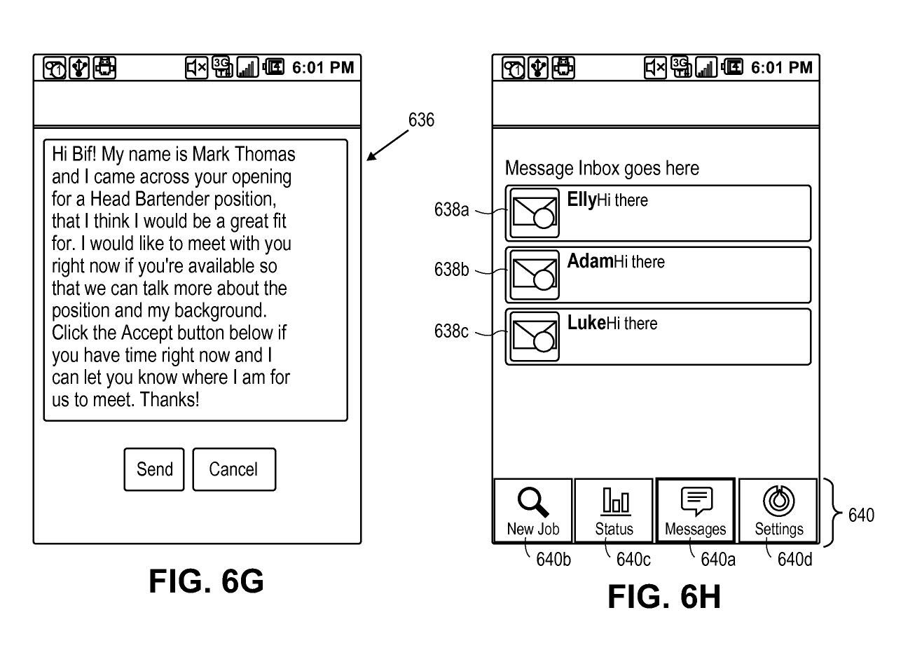

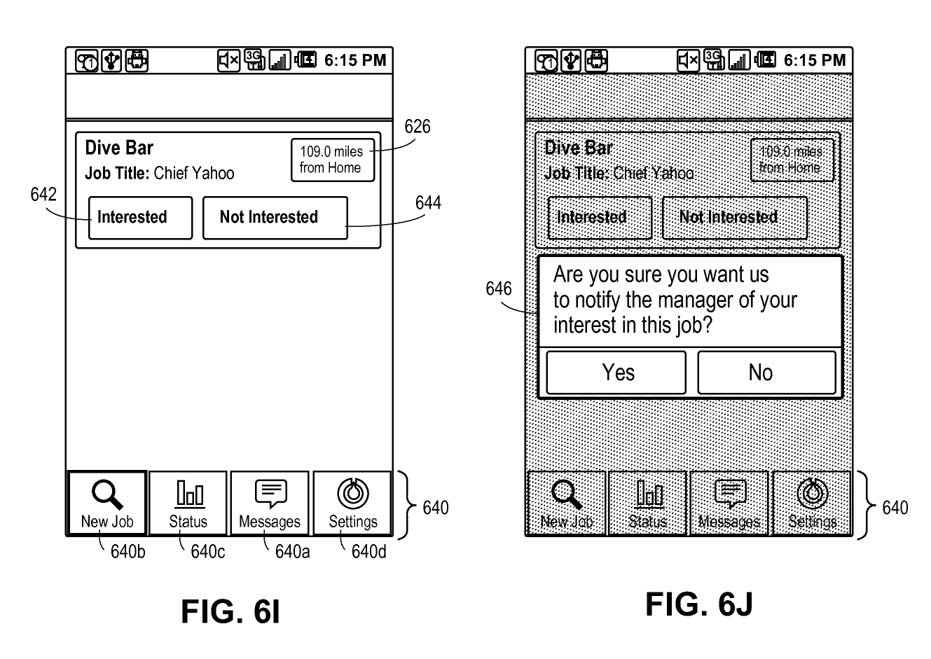

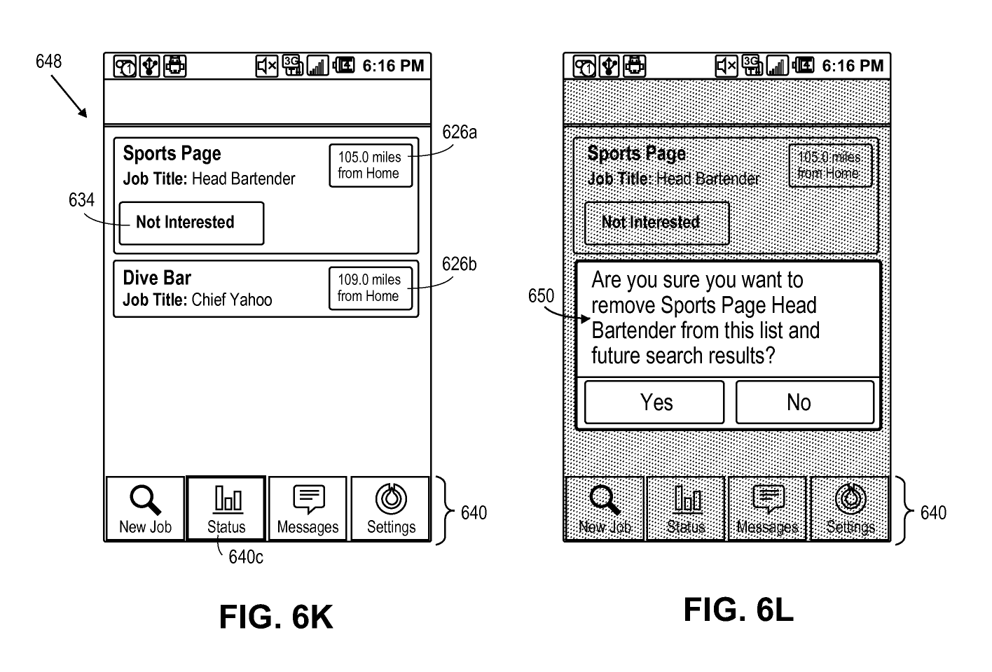

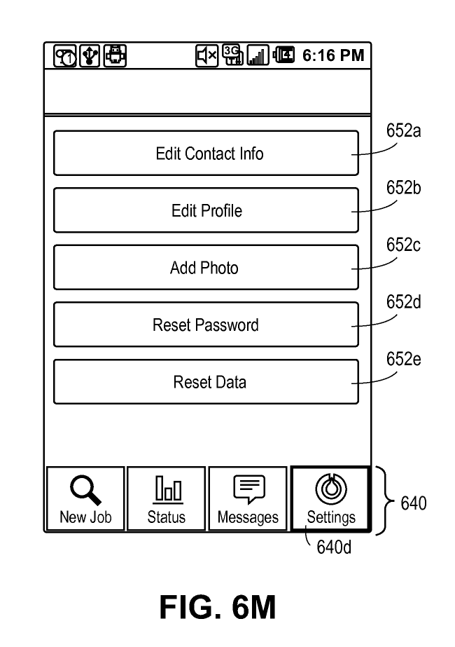

With continuing reference to FIG. 3, and with further reference to FIG. 5 and FIGS. 6A-M, a method 500 for connecting a candidate 325 to an employer 315 based at least upon their respective current locations 312, 322 and/or other location or distance data (e.g., distance from job location to candidate's residence), while providing the capability to indicate they want to meet now through their mobile communication devices 310, 320 comprises, at 502, the candidate 325 downloading and executing or launching the application 338 on mobile communication device 320 to begin a location-based mobile-to-mobile employment search. At 504, the application 338 determines a current location 322 of the candidate's mobile communication device 320 and/or the candidate 325 enters or selects a current location, zip code or other location for which an employment search is to be conducted and that may be compared to the candidate's residence location.

For example, referring to FIG. 6A, the application may generate a user interface 600 that is displayed to the candidate 325 on the mobile communication device 320 allowing the candidate 325 to select a button 602 to search for employment opportunities near a current location, e.g., within a predetermined distance or pre-determined number of miles from the candidate's current location and/or residence, or manually enter a location (e.g. city, state) or zip code into a field 604. After entry or selection of the location for which a search is to be conducted, the user presses “start” 606 to proceed.

Referring again to FIG. 5, at step 506, the application 338 then presents one or more screens to the candidate 325 for creating a candidate profile 328 (if a candidate profile 328 has not already been created). Step 506 may involve a candidate 325 who is using the application 338 for the first time, or who wants to edit a previously created profile 328.

For example, referring to FIGS. 6B-C, examples of types of data included in a candidate profile 328 include one or more or all of job type or category 608, a current or previous job title 610, years of experience 612, particular areas of experience for a job type or category 616 (e.g., barbacking, managing a team and martini guru in the example involving a bartender), residence zip code 614, names or contact information of references, availability (e.g., days, hours) and other profile 328 criteria or attributes. For this purpose, when the candidate 325 first selects a job category (e.g., bartending), the application 338 will then present the other options or fields to be selected or filled in for that particular job category. Thus, it will be understood that a profile for bartending, for example, will have different types of data or options of data that can be selected compared to a profile for construction, which will have different types of data compared to a profile for retail clerk. Accordingly, FIGS. 6B-C are provided to illustrate one example of how profiles may be configured and created by the candidate 325.

Further, as shown in embodiment illustrated in FIG. 6C, the candidate profile 328 also includes data 618 indicating whether the candidate 325 wants employers 315 to see the candidate's current location 312 or other location or distance data such as distance from job location to candidate's residence. In the illustrated embodiment, the profile allows the candidate 325 to select one of these types of location or distance data to be displayed, and in this example, the candidate 325 has indicated that the candidate 325 allows an employer 315 to view the distance between the candidate's current location 322 (e.g., as determined from the current location of the candidate's mobile communication device 320) and the employer's current location 312 (e.g., as determined from the current location of the employer's mobile communication device 320. It should be understood that embodiment may involve one or both of the distance between current locations and the distance between the job location and the candidate's residence.

Referring again to FIG. 5, and with continuing reference to FIG. 6C, after the candidate 325 has entered or selected the requested or applicable data, at step 508, the candidate 325 selects “create profile and search jobs” 620 to initiate a search for employment opportunities, and the application 338 executing on the candidate's mobile communication device 320 communicates with intermediate computer 330. At step 510, the candidate's profile 328 (and candidate's current location 322 as necessary) are transmitted from the mobile communication device 320 to the intermediate computer 330 and stored to the database 332 with other candidate and employer profiles 328, 318.

At step 512, the profile manager 336 receives the candidate's profile 328 and compares it with employer profiles 318 (that were already generated and stored to the database 332) to determine which employer profiles 318 match or satisfy pre-determined criteria relative to candidate's profile 328.

For example, the profile engine 336 may be configured, or the employer 315 and/or candidate 325 may specify, that there must be at least a 75% match between the data of the employer profile 318 and the data of the candidate profile 328. As another example, an employer 315 and/or candidate 325 may specify that certain attributes must be a match regardless of whether other items match. For example, the employer 315 may have specified that the candidate 325 must, at a minimum, be a “martini guru” to be considered for the employer's bartending position. It will be understood that various other pre-determined matching criteria can be utilized, and that these matching criteria are provided as examples of how embodiments may be implemented.

At step 514, the profile engine 338 completes the comparisons and selects employer profiles 318 that satisfy the pre-determined matching criteria. If necessary, e.g., as selected by the employer 315 and/or candidate 325, at step 516, the profile engine 336 may be configured to exclude or filter out any search results (even if they satisfy the pre-determined matching criteria) if, for example, the current location 322 of the candidate 325 (based on current location of candidate's mobile communication device 320) is not within a pre-determined distance of the current location 312 of the employer 310 (based on current location of employer's mobile communication device 310) and/or the location of candidate's residence (which was part of the candidate profile 328) not being within a pre-determined distance of job location or employer zip code (which is part of the employer's profile 318, an example of which is described in further detail below). It will be understood that step 516 may be performed before or after step 514, and that embodiments may involve other sequences.

At step 518, the search results or employer profiles 318 selected by the profile engine 336 are accessed by or transmitted to and displayed on the candidate's mobile communication device 320. For example, referring to FIG. 6D, the profile engine 336 has compared the candidate's profile 328 with various employer profiles 318 and determined that profiles of two employers 315a,b (Sports Page and Dive Bar) matched the candidate's profile or satisfied pre-determined matching criteria and are thus selected as search results. In the illustrated embodiment, data of the employer profile 318 that was selected by the profile engine 336 and displayed to the candidate 325 includes the employer names 622a,b (e.g., Sports Page) and a job title 624a,b (e.g., Head Bartender) of the open position. Further, according to embodiments, each search result is displayed with one or more types of location data.

In the embodiment illustrated in FIG. 6D, data of selected employer profiles 318 are displayed together with distances 626a,b between a location of the employer or job location and the residence of the candidate 625 (as determined from the job location or zip code and residence data or zip code entered during creation of profiles 318, 328). Further, as illustrated, the data of selected employer profiles 318 and the location or distance data 626 are displayed within a single screen or view on the candidate's mobile communication device 320. According to another embodiment, the data of employer profiles 318 selected by the profile engine 336 is displayed together with a distance 628 between current locations of the candidate and employer within a single view or screen. According to a further embodiment, the data of the employer profiles 318 is displayed together with both types of distance or location data 626, 628 within a single screen or view (e.g., as shown in FIG. 6E).

Referring again to FIG. 5, and with continuing reference to FIG. 6D, the candidate 325 selects an employer 315 by touching the display screen or clicking on the employer button at step 520, and at step 522, and with further reference to FIG. 6E, a screen with additional information and/or options related to the selected employer 315 is presented to the candidate 325.

In the illustrated embodiment, as shown in FIG. 6D, the candidate 325 is initially presented with search results containing an employer name 622, job title 624 and one type of location or distance data 626, and when the candidate 325 selects an employer 315, then as shown in FIG. 6E, the application 338 displays further distance information 628, e.g., in the form of a distance between current locations of the candidate 325 and employer 315 (as determined from the mobile communication device locations 312, 322) and buttons 630, 632, 634 that provide options for contacting, expressing interest or no interest in the employer 315.

In the illustrated embodiment, options presented to the candidate 325 include buttons that can be selected to send an electronic message to the employers mobile communication device to schedule a meeting or interview to “Meet Now” 630 in real time, “Meet Later” 632 or, if the candidate 325 is not interested in the employer 315 (e.g., if one of the distances is too far away for the candidate 325) the candidate 325 can select “Not Interested” 634.

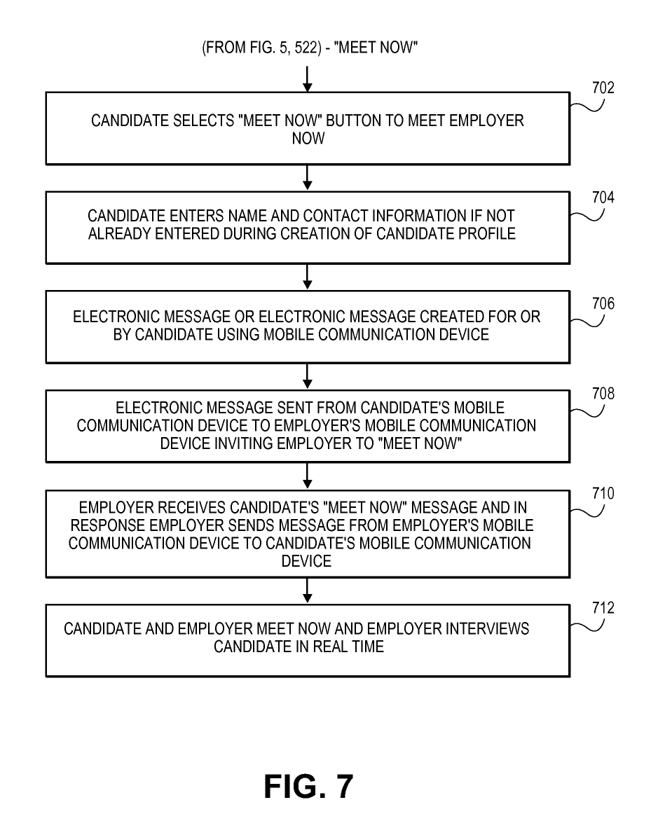

With further reference to FIGS. 6F and 7, when the candidate 325 selects the “Meet Now” button 630 at step 702, at step 704, the candidate 325 may be requested to enter personal and contact information 634 (if not previously entered when the application is launched, when the candidate profile 328 was created, or if the candidate 325 is using the application 338 for the first time) such as first and last names, email address and password information. At step 706, and with further reference to FIG. 6G, the application 338 generates a message 636 for the candidate 325 to be sent to the employer 315 and indicating that the candidate 325 wants to meet the employer 315 now to discuss the (Head Bartender) position. The application 338 may display a standard message that is populated with data from the employer and/or candidate profiles 318, 328, e.g., populated with the candidate's name from FIG. 6F and the job title from FIG. 6E. According to another embodiment, the candidate 325 creates a message 636 by typing or speaking the message into the mobile communication device 320.

At step 708, the electronic message 636 is sent from candidate's mobile communication device 320, through the intermediate computer 330, and to employer's mobile communication device 310, and at step 710, the employer 315 receives the candidate's “meet now” invitation message. Although not illustrated, the message received and viewed by the employer 315 may include the candidate's contact information (such as a mobile phone number or e-mail address) such that the employer 315 can respond to the message 636, which is directed back to the candidate's mobile communication device 320 through the intermediate computer 330, such that, as shown in FIG. 6H, the candidate 325 views messages 638a-c (generally, messages 638) received from various employers 315 after selecting the “Messages” tab 640a from the navigation menu 640 which, in the illustrated embodiment, and as described in further detail below, includes tabs 640a-d for Search, Status, Messages and Settings. In an alternative embodiment, if the candidate 625 has entered contact information, the employer 615 can contact the candidate 625 directly without sending a message through the intermediate computer 330. Further, although not illustrated, when the candidate 325 selects a message from the Inbox shown in FIG. 6H, the opened message includes the employer's message in response to the “Meet Now” invitation and may also include the employer's contact information (such as phone number or Email address) so that the candidate can call or e-mail the employer directly without communicating through the intermediate computer 330. Further, the message from the employer 315 may also include the employer's current location 312 or distance from the candidate's current location 322.

Assuming the employer 315 agrees (or if the candidate 325 is accepting an invitation to meet sent by the employer 315), at step 712, the candidate 325 and employer 315 meet now at an agreed upon location and time. For example the “meet now” invitation allows candidates 325 and employers 315 to schedule interviews or meetings and meet in “real time” on the same day, e.g., within a matter of minutes or hours. Thus, while the candidate 325 and employer 315 are communicating and scheduling an interview in real time during use of their mobile communication devices 310, 320, they can meet very shortly thereafter on the same day.

According to one embodiment, the candidate 325 and employer 315 meet at an agreed upon place and time, and the application 338 generates and displays a map to the candidate 325 showing a route from the candidate's current location 322 (as determined from the current location data of the candidate's mobile communication device 320) to the meeting location. For this purpose, the application 338 can be configured to read or access a meeting location entered by the candidate 325 or employer 315 in a predetermined field of an electronic message format, or the candidate 325 can enter the meeting location in a separate field or screen, in response to which the application 338 generates and displays the map to the candidate 325.

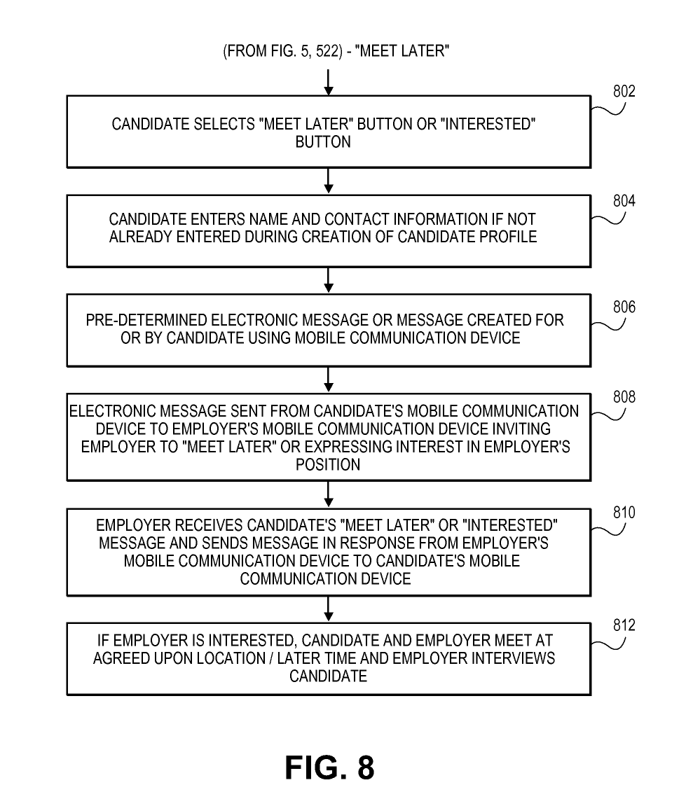

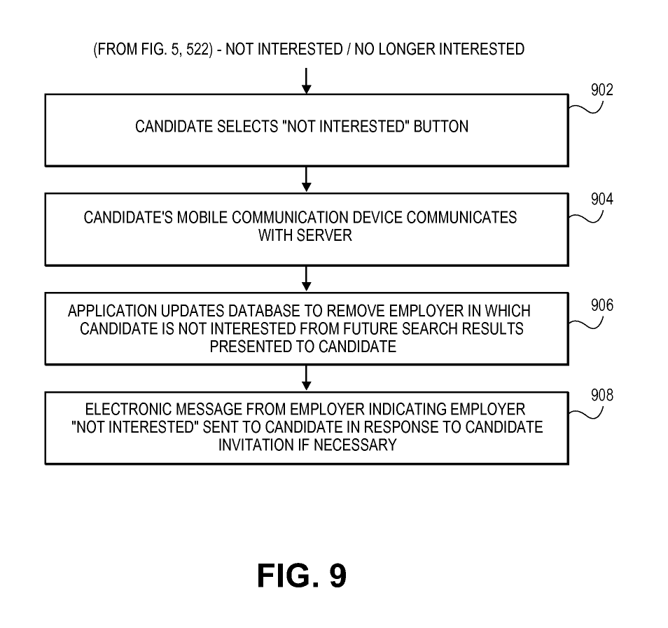

Referring again to FIG. 6E and with further reference to FIG. 8, if the candidate 325 does not want to “Meet Now” but the candidate 325 is still interested in the opportunity, the candidate 325 may invite the employer 315 to “Meet Later” by pressing or selecting the “Meet Later” button 632 to schedule a time to discuss the employment opportunity, e.g., tomorrow, or later during the week or at some other time.

More particularly, in the illustrated embodiment, the candidate 325 has now selected the employer “Dive Bar” such that the Meet Now 630, Meet Later 632 and Not Interested 634 buttons are presented to the candidate 35 for Dive Bar. In this example, the candidate 325, at step 802, selects “Meet Later” 632 such that the application 338 then displays a screen such as the screen shown in FIG. 6I that allows the candidate 325 to indicate to employer Dive Bar that the candidate is “Interested” 642 in the employment opportunity for “Chief Yahoo” at Dive Bar.

FIG. 6I also illustrates, as described above with reference to FIG. 6D, that location or distance data 626 and/or 628 is displayed together with the employer profile information and/or buttons 642, 644 to contact or express interest in the employer 315.

Referring again to FIG. 8, after selecting “Interested” 642 in FIG. 6I, at step 804, application 338 may request the candidate 325 to enter personal and contact information 634 (if not previously entered when the application 338 is launched, when the candidate profile 328 was created, or if the candidate 325 is using the application 338 for the first time) such as first and last names, email address and password information as discussed above.

At step 806, and with further reference to FIG. 6J, the application 338 may generate a message 646 asking the candidate 325 to confirm that the employer 315 should be notified of the candidate's interest, and after confirmation, the electronic “Meet Later” invitation or “Interested” message is sent from the candidate's mobile communication device 320 to the employer's mobile communication device 310 through the intermediate computer 330 at step 808.

At step 810, the employer 315 receives the candidate's “Meet Later” invitation or “Interested” message and, if the employer 315 is likewise interested, sends an electronic message in response from employer's mobile communication device 310 to candidate's mobile communication device 320 through the intermediate computer 330 as discussed above, or directly to the candidate's mobile communication device 320 as a voice message, SMS or e-mail message if the candidate provided contact information to the employer 315, and at step 812, if the employer 315 is interested, the candidate 325 and employer 315 meet at agreed upon location at the later time to discuss the employment opportunity.

FIG. 6K illustrates an example of a status summary 648 displayed to the candidate 315 when the “Status” tab 640c is selected from the navigation menu 640. In this example, the candidate 315 has already selected “Meet Now” or “Meet Later” or “Interested” as discussed above for the employer “Sports Page,” and the application 338 displays a “Not Interested” button 634 in case the candidate 315 is no longer interested or finds other employment.

Referring to FIG. 9 and with continuing reference to FIGS. 6E and 6K-L, the candidate 315 selects “Not Interested” 634 at step 902 as shown in FIG. 6K. This stage may involve the candidate 315 initially selecting the “Not Interested' button 634 after first reviewing a search result or invitation from the employer 315, or later deciding that the candidate 315 is no longer interested in an employer 325. In response to the “Not Interested” 634 selection and candidate confirmation 650 shown in FIG. 6L, the application 338, at step 904, communicates with the intermediate computer 330, and the profile engine 336, at 906, updates the database 332 so that the employer 315 in which the candidate 325 is not interested is not presented to the candidate 325 in future search results. Further, if necessary e.g., if the employer 315 invited the candidate 325 to meet but the candidate 325 was not interested, an electronic message can be sent from the candidate's mobile communication device 310 to the employer's mobile communication device 320 indicating that the candidate 315 is “Not Interested” in that employment opportunity.

While embodiments have been described with reference to examples involving two employers 315, and meet or interview options such as “Meet Now,” “Meet Later” and “Not Interested,” it will be understood that embodiments may involve other numbers of employers 315, and employer data and/or meet or interview options may be displayed together with one or multiple types of location and distance data to provide candidates with location information to assess which employers 315 are within a desired geographic area relative to the candidate 325.

Further, while certain embodiments are described above with reference to an interface including a sequence of screens, some of which may be accessed in various orders via the menu bar 640 it will be understood that the candidate 325 can navigate back and forth among various screens and in various sequences via the menu bar 640 to search for employment opportunities, view search results or status, view messages from employers that were sent in response to candidate invitations (or from employers who invited the candidate to meet, as discussed below)

As shown in FIG. 6M, a candidate 325 can adjust settings 652a-e via the menu bar 640 and enter or update contact information (e.g., phone number or e-mail address), profile data e.g., qualifications, job titles, experience, etc.), reset a password or reset such data. Further, as shown in FIG. 6M, the candidate 325 can add a photo to the profile 328 so that when the candidate 325 and employer 315 meet in response to a candidate invitation, the employer 315 will know what the candidate 325 looks like, which may be particularly beneficial if the meeting is at a location with a large number of people such as a restaurant.

It will be understood that it may not be necessary to display all of the screens shown in FIGS. 6A-M. For example, certain screens such as profile creation screens and contact information screens may be necessary for first time users or if a candidate 325 is changing or updating information via the navigation menu 640. Thus, after initial entry, those types of screens can be displayed if a candidate 315 requests them, e.g., by clicking the settings 640d tab.

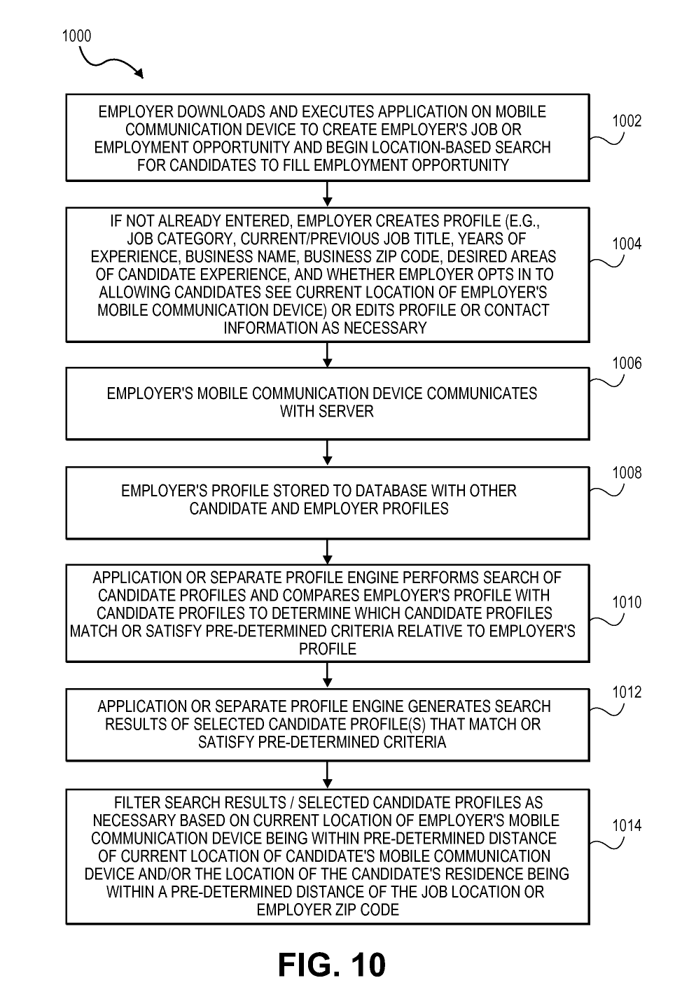

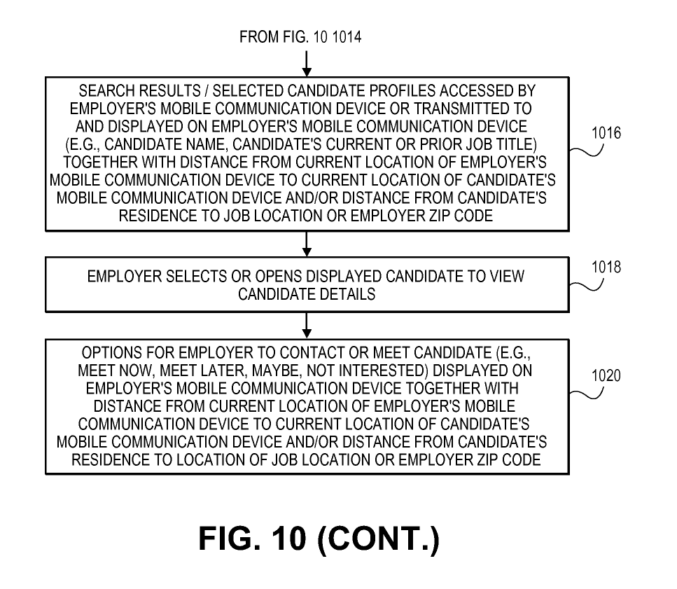

Embodiments described above with reference to FIGS. 3-9 explain how a candidate 325 can search for employment opportunities, view employer profile data together with location or distance data 626 and/or 628, and initiate contact with and meet the employer 315 in real time via mobile communication devices 310, 320. The following description with reference to FIGS. 10-14 shows how embodiments may also be utilized by employers 315 to search for qualified candidates 325 who match the employers need or profile or satisfy pre-determined matching criteria, and how employers 315 can view candidate profile data together with location or distance data, and initiate contact with the candidate 325 in real time while utilizing mobile communication device 310, 320. It will be understood that various details describe above are also applicable to employer searches, and thus certain details are not repeated for ease of explanation.

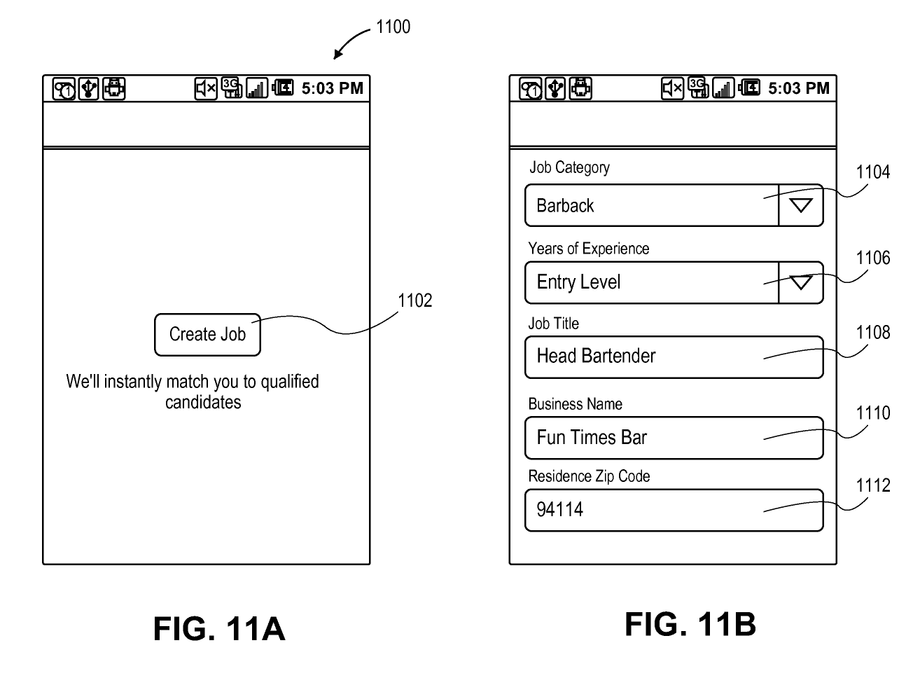

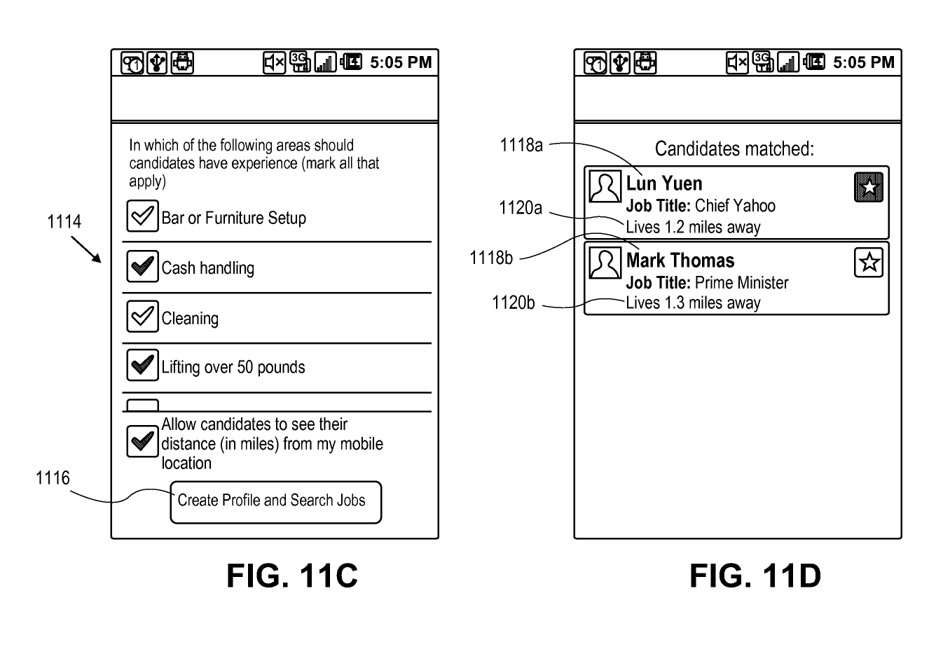

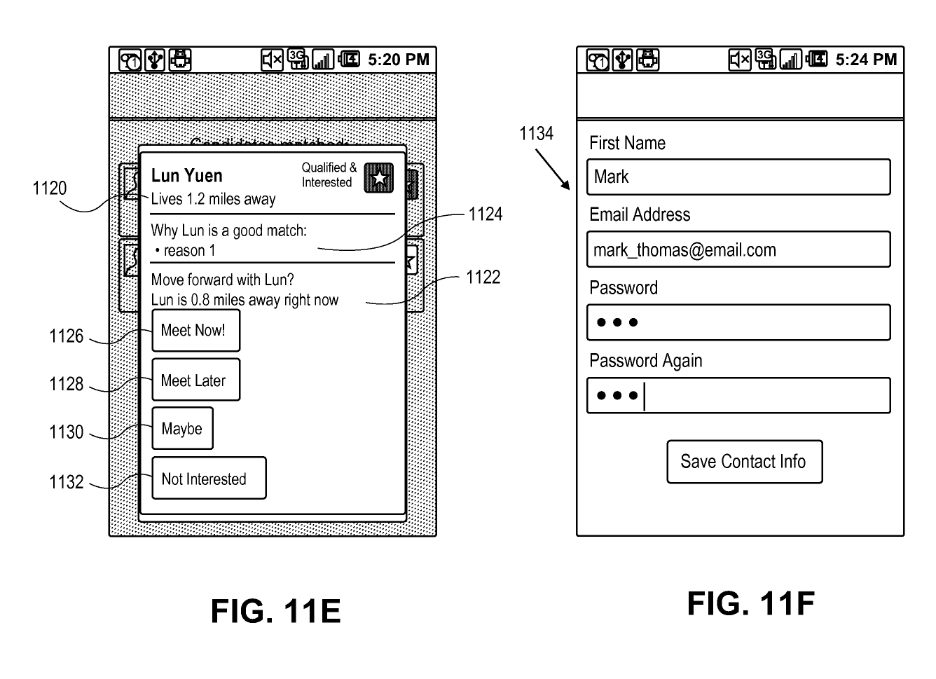

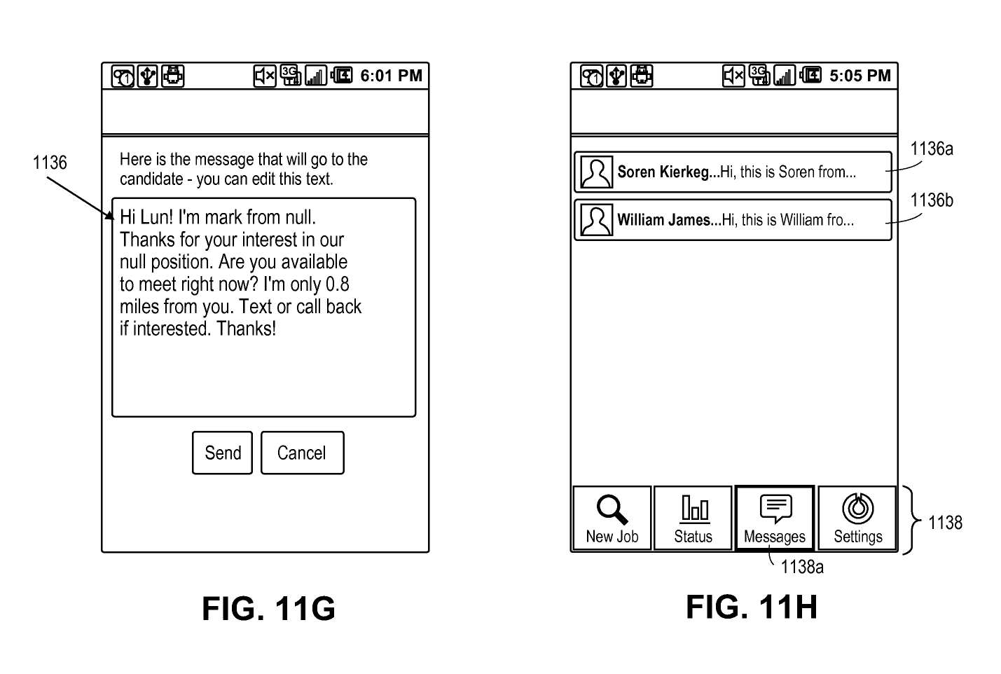

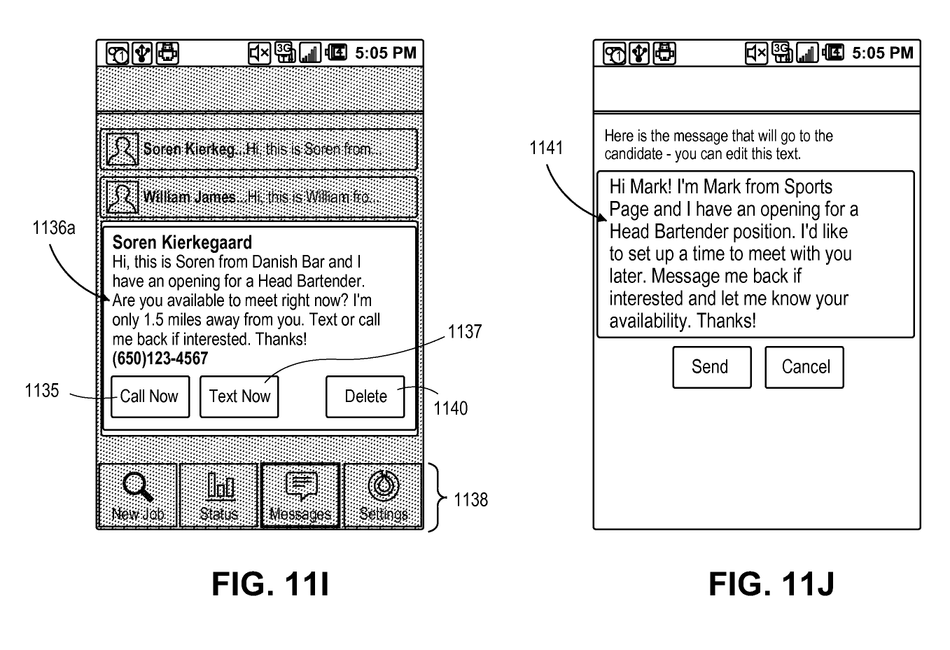

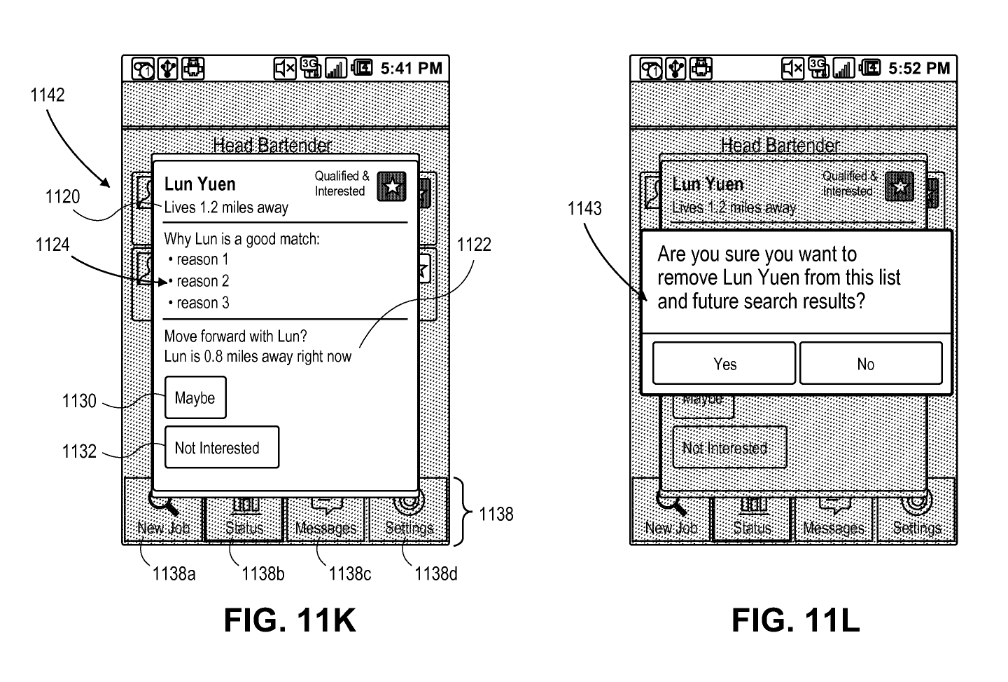

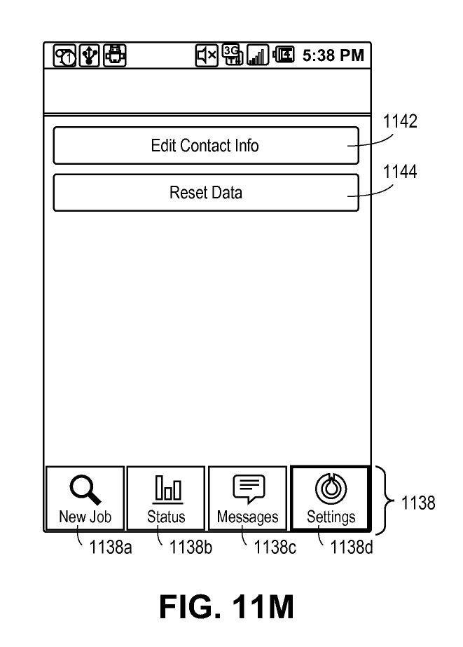

Referring to again to FIG. 3, and with further reference to FIGS. 10 and 11A-M a method 1000 for connecting an employer 315 to a candidate 325 based at least upon their respective locations while providing the capability to indicate they want to meet now through their mobile communication devices 310, 320 comprises, at 1002, the employer 315 downloading and executing the application 338 on mobile communication device 310 to generate an interface 1100 that allows the employer 315 to create a job or employment opportunity by, for example, clicking or selecting “Create Job” 1102 as shown in FIG. 11A, and to begin location-based search for candidates 325 to fill that job. At step 1004, the application 338 presents one or more screens to the employer 315 for creating an employer profile 318 (if an employer profile 318 has not already been created). Step 1004 may involve an employer 315 who is using the application 338 for the first time, who is creating a new job, or who wants to edit a previously created employer profile 318.

For example, referring to FIGS. 11B-C, examples of types of data included in an employer profile 318 include one or more or all of job type or category 1102, a desired number of years of experience or experience level 1106, a job title 1108, employer or business name 1110, a location or zip code 1112 of the employer 315 or job location, particular desired or required areas of experience 1114 for a particular job type or category, names or contact information of references, availability (e.g., days, hours) and other criteria or attributes. In the illustrated example, the employer's profile 318 includes data such as Barback (Job Category), Entry Level (Years of Experience), Head Barback (Job Title), Fun Times Bar (Employer), 94114 (Business or Job Location or Zipcode), and desired areas of experience including Cash handling and lifting over 50 pounds.

For this purpose, when the employer 315 first selects a job category (e.g., Barback or bartending), the application 338 presents other options or fields to be selected or filled in for that particular job category. Thus, as explained above, an employer profile 318 for bartending, for example, will have different types of data compared to a profile for construction, which will have different types of data compared to a profile for retail clerk. Accordingly, FIGS. 11B-C are provided to illustrate one example of how embodiments may be implemented with regard to an employer 315 seeking a bartender.

Further, as shown in embodiment illustrated in FIG. 11C, the employer profile 318 also includes an indication 1116 of whether the employer 315 wants candidates 325 to see the employer's location or distance data. In the illustrated embodiment, the employer 315 has indicated that the employer 315 allows a candidate 325 to view a distance between the employer's current location 312 (e.g., as determined from the current location of the employer's mobile communication device 310) and the candidate's current location 322 (e.g., as determined from the current location of the candidate's mobile communication device 320).

Referring again to FIG. 10, after the employer 315 has completed selecting or entering data of the profile 318, at step 1008, the employer 315 selects “create profile and search jobs” (candidates) to initiate a search for candidates 325 seeking employment opportunities. The application 338 executing on the employer's mobile communication device 310 communicates with intermediate computer 330, and at step 1008, the employer's profile 318 (and employer's current location 312 as necessary) are transmitted from the mobile communication device 310 to the intermediate computer 330 and stored to the database 332 with other candidate and employer profiles 318, 328.

At step 1010, the separate profile engine 336 (or the application 338 as discussed above) receives the employer's profile 318 and compares it with candidate profiles 328 (that were already generated and stored to the database 332) to determine which candidate profiles 328 match or satisfy pre-determined criteria relative to the employer's profile 318 as discussed above with reference to FIG. 5.

At step 1012, the profile engine 336 completes the comparisons and selects candidate profiles 328 that satisfy the pre-determined matching criteria. If necessary, e.g., as selected by the employer 315 and/or candidate 325, at step 1014, the profile engine 336 may be configured to exclude or filter out any search results (even if they satisfy the pre-determined matching criteria) if, for example, the current location 322 of the candidate 325 (based on current location of candidate's mobile communication device 320) is not within a pre-determined distance of the current location 312 of the employer 315 (based on current location of employer's mobile communication device 310) and/or the location of candidate's residence (which was part of the candidate profile 328) not being within a pre-determined distance of job location or employer zip code (which is part of the employer's profile 318. As discussed above, step 1014 and other steps may be performed in other sequences.

At step 1016, the search results or candidate profiles 328 selected by the profile engine 336 are accessed by or transmitted to and displayed on the employer's mobile communication device 310. For example, referring to 11D, the profile engine 336 has compared the employer's profile 318 with various candidate profiles 328 and determined that profiles of two candidates (Lun Yuen and Mark Thomas) matched the employer's profile 318 or satisfied pre-determined matching criteria (e.g., matched certain or a minimum number of profile attributes or requirements). In the illustrated embodiment, data of the profile of a matching candidate seeking employment and displayed to the employer 315 includes the candidate names 1118a,b (e.g., Lun Yuen and Mark Thomas) and their job titles 1120a,b (e.g., Chief Yahoo and Prime Minister). Further, according to embodiments, each search result is displayed with one or more types of location data. An indicator (such as a star as shown in FIGS. 11D-E) may be provided to indicate that a candidate 325 is a match or satisfies pre-determined matching criteria and is interested in the employer's employment opportunity.

In the embodiment illustrated in FIG. 11D, data of candidate profiles 328 selected by the profile engine 336 are displayed together with “Lives 1.2 miles away” or distances 1120a,b between a location of the employer 315 or job location and the residences of the candidate 325a,b (as determined from the job location or zip code and residence data or zip code entered during creation of profiles 318, 328). According to another embodiment, the data of candidate profiles 328 selected by the profile engine 336 is displayed together with a distance 1122 between current locations 312, 322 of the candidate 325 and employer 315 within a single view or screen. According to a further embodiment, the data of the candidate profiles 328 is displayed together with both types of distance or location data 1120, 1122 within a single screen or view (e.g., as shown in FIG. 11E).

Referring again to FIG. 10, and with continuing reference to FIG. 11D, employer 315 selects a candidate 325 by touching the display screen or clicking on the candidate button at step 1018, and at step 1020, with further reference to FIG. 6E, a screen with additional information and/or options related to the selected candidate 325 is presented to the employer 315.

In the illustrated embodiment, as shown in FIG. 11D, the employer 315 is initially presented with search results containing a candidate name, job title and distance of the job location from the candidates residence, and an indicator (such as a star as shown in FIG. 11D) that the candidate 325 is a match or satisfies pre-determined matching criteria and is interested in the employer's employment opportunity. When the employer 315 selects a candidate 325, then as shown in FIG. 11E, the application 338 displays further location or distance information 1122 in the form of a distance between current locations 312, 322 of the candidate 325 and employer 315 (as determined from the mobile communication devices 310, 320), a summary or list 1124 of reasons why the candidate 325 is a good match for the employer 315, and buttons that provide options for contacting, expressing interest or no interest in the candidate 325.

In the illustrated embodiment, options presented to the employer 315 include buttons 1126, 1128, 1130, 1132 that can be selected to send an electronic message to the candidate's mobile communication device to schedule a meeting or interview to “Meet Now” in real time, “Meet Later” or, to indicate that the employer 315 is “Maybe” interested, and if the employer 315 is not interested in the candidate 325 (e.g., if one of the distances is too far away for the candidate 325 or the reasons listed are not what the employer 315 is seeking) the employer 315 can select “Not Interested” to remove the candidate 325 from the list and/or future search results.

With further reference to FIGS. 11F and 12, when the employer 315 selects the “Meet Now” button 1126 at step 1202, and at step 1204, the employer 315 may be requested to enter personal and contact information 1134 (if not previously entered when the application 338 is launched, when the employer profile 318 was created, or if the employer 315 is using the application 338 for the first time) such as first and last names, Email address and password information. At step 1206, and with further reference to FIG. 11G, the application 338 generates a message 1136 for the employer 315 to be sent to the candidate 325 and indicating that the employer 315 wants to meet the candidate 325 (Lun Yuen) now to discuss the Head Barback position. According to one embodiment, the application 338 displays a standard message 1136 that is populated with data from the employer and/or selected candidate profiles 318, 328, e.g., populated with the candidate's name, employer's name and job title. According to another embodiment, the employer 315 creates a message 1136 by typing or speaking the message into the mobile communication device 310.

The electronic message 1136 may be the first communication between the employer 315 or candidate 325, or the electronic message 1136 may be a response to a prior message or invitation sent by the candidate 325 to the employer 315. For example, as shown in FIG. 11G, the candidate 325 has expressed interest in the position (e.g., by sending a “Meet” invitation or indicating that the candidate is Interested”), and the employer 315 is responding to the candidate's earlier invitation or message.

At step 1208, the electronic message 1136 is sent from the employer's mobile communication device 310, through the intermediate computer 330 and to candidate's mobile communication device 320, and at step 1210, the candidate 325 receives the employer's “meet now” invitation message 1136.

The message 1136 sent by the employer 310 and received and viewed by the candidate 325 may include the employer's contact information 1134 (such as a mobile phone number or e-mail address) such that the candidate 325 can respond to the message 1136, which his directed back to the employer 315 through the intermediate computer 330.

For example, FIG. 11H illustrates a navigation menu 1138 including a Messages tab 1138a that can be selected to view received or sent messages. In the illustrated example, sent message 1136a is from employer 315 (Soren Kierkegaard) who has contacted a candidate 325 and invited the candidate 325 to meet now and has provided contact information (such as a phone number as shown in FIG. 11I) to the candidate 325. Further, the application 338 displays buttons to allow the candidate 325 respond back to the employer 315 by “Call Now” 1138 or “Text Now” 1140, or if the candidate 325 is not interested, the candidate 325 can “Delete” 1140 the message 1136a. In this manner, after an initial contact has been established, the candidate 325 can contact the employer 315 directly without sending a message through the intermediate computer 330.

Further, although not illustrated, when the employer 315 selects a message from the Messages box, the opened message includes the candidate's inquiries to an employer 315 or responses to employer 315 invitations, and may also include the candidate's contact information (such as phone number or Email address) so that the employer 315 can call or e-mail the candidate 325 directly without communicating through the intermediate computer.

Assuming the candidate 325 agrees, at step 1212, the candidate 325 and employer 315 meet now at an agreed upon location and time. For example the “meet now” 1126 invitation allows the employer 315 to meet candidates 325 in “real time” on the same day, e.g., within a matter of minutes or hours. Thus, while the candidate 325 and employer 315 are communicating and scheduling an interview in real time during use of their mobile communication devices 310, 320, the candidate 325 and employer 315 meet very shortly thereafter on the same day.

According to one embodiment, the candidate 325 and employer 315 meet at an agreed upon place and time, and the application 338 generates and displays a map to the employer 315 showing a route from the employer's current location 312 (as determined from the current location data of the employer's mobile communication device 310) to the meeting location. For this purpose, the application 338 can be configured to read or access a meeting location entered by the candidate 325 or employer 315 in a predetermined field of an electronic message format, or the employer 315 can enter the meeting location in a separate field or screen, in response to which the application 338 generates and displays the map to the employer 315.

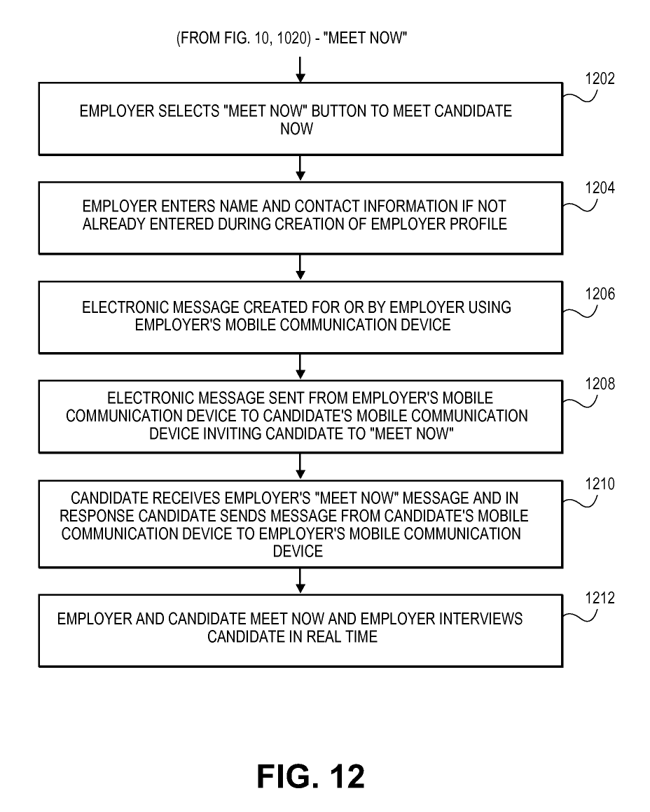

Referring again to FIG. 11E, and with further reference to FIG. 13, if the employer 315 does not want to send a “Meet Now” 1126 invitation to the candidate 325, or accept a candidate's invitation to “Meet Now,” but the employer 315 is still interested in the candidate 325, the employer 315 may invite the candidate 325 to “Meet Later” by pressing button 1128, e.g., to meet tomorrow or a later during the week or at some other time, or indicate that the employer 315 is “Maybe” 1130 interested in the candidate 325.

More particularly, in the illustrated embodiment, the employer 315 has selected candidate 325 “Lun Yuen” and such that the “Meet Now” 1126, “Meet Later” 1128, “Maybe” 1130 and “Not Interested” 1132 buttons are presented to the employer 315 for candidate Lun Yuen. In this example, the employer 315, at step 1302, selects “Meet Later” 1128 or “Maybe” 1130 such that the application 338 then displays a screen such as the screen shown in FIG. 11J that allows the employer 315 to send a message 1140 to indicate to the candidate 325 Lun Yuen that the employer “Maybe” interested or that the employer 315 would like to “Meet later” to discuss the Head Barback opportunity at Sports Page.

Referring again to FIG. 13, after the employer 315 selects “Meet Later” 1128 or “Maybe” 1130, at step 1304, the application 338 may request the employer 315 to enter personal and contact information 1134 (if not previously entered when the application 338 is launched, when the employer profile 318 was created, or if the employer 315 is using the application 338 for the first time) such as first and last names, Email address and password information as discussed above.

At step 1306, the electronic message 1140 generated for “Meet Later” 1128 or “Maybe” 1130 is sent from the employer's mobile communication device 310 to the candidate's mobile communication device 320 through the intermediate computer 330 at step 1308 (e.g. if this is the first communication between the employer 315 and candidate 325) or directly without the electronic message 1140 being directed through the intermediate computer 330 if the employer 315 is responding to utilizing contact information provided by the candidate 325). At step 1310, the candidate 325 receives the employer's “Meet Later” invitation or “Maybe” message and, if the candidate 325 is interested, sends an electronic message in response from the candidate's mobile communication device 320 to the employer's mobile communication device 310 through the intermediate computer 330 as discussed above, or directly to the candidate 325 as a voice message, SMS or e-mail message if the employer 315 provided contact information to the candidate 325. At step 1312, if the candidate 325 is interested, or if the employer 315 has agreed to accept a candidate's invitation, the candidate 325 and employer 315 meet at agreed upon location at the later time to discuss the employment opportunity.

FIG. 11K illustrates an example of a status summary 1142 displayed to the employer 315 when “Status” tab 1138b is selected from the navigation menu 1138 and in which the employer 315 has previously selected “Meet Now” 1126 or “Meet Later” 1128 or “Interested” as discussed above for the candidate 325 “Lun Yuen.” The application 338 may display a “Maybe” 1130 or “Not Interested” 1132 button in case the employer 315 is less interested or is no longer interested in the candidate 325 or has already found a candidate 325 for the position.

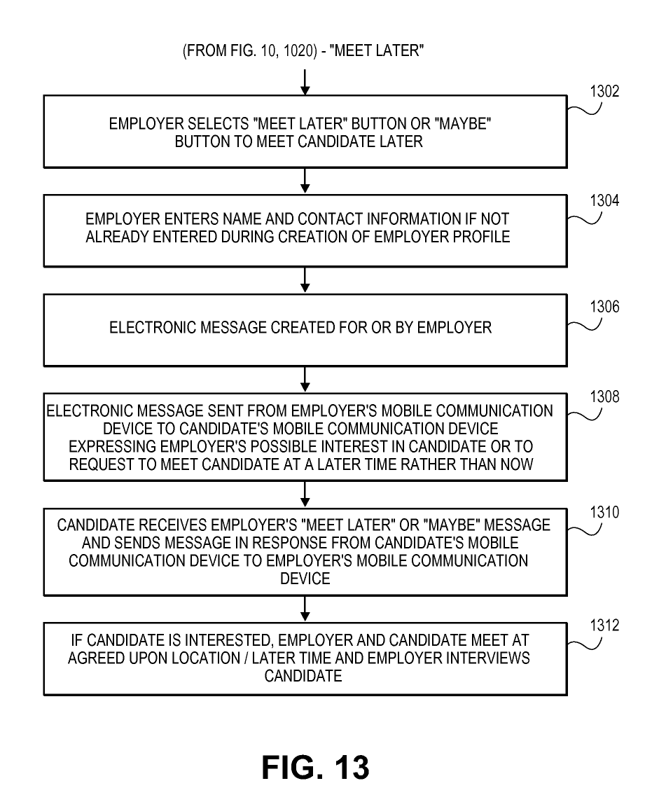

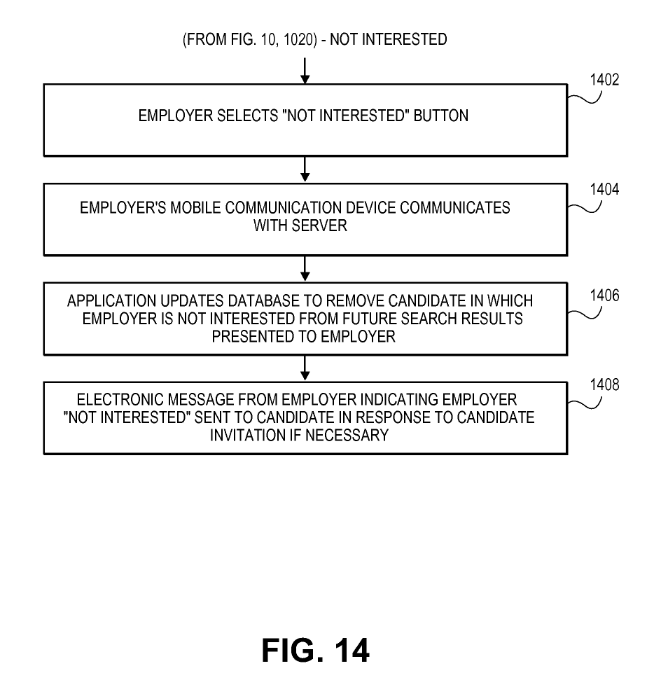

For example, referring to FIG. 14 and with continuing reference to FIGS. 11E and 11K-L, the employer 315 selects “Not Interested” at step 1402, by initially selecting the “Not Interested' button 1132 as shown in FIG. 11E, e.g., when first reviewing candidate 325 “Lun Yuen,” or later deciding that the candidate 325 is no longer a match, the employer 315 changing a status, or responding to an invitation or message from the candidate 325 indicating that the employer 315 is not interested in the candidate 325. In response to the “Not Interested” 1132 selection, the application 338 confirms 1140 the employer's 115 decision, and at step 1404, communicates with the intermediate computer 330, and the profile engine 336, at 1406, updates the database 332 so that the employer 315 in which the candidate 325 is not interested is not presented to the candidate 325 in future search results. At step 1408, if necessary, e.g., as a response to a candidate 325 invitation to meet, an electronic message can be sent to the candidate's mobile communication device 320 indicating that the employer 315 is not interested in the candidate 325.

While embodiments have been described with reference to examples involving two candidates 325, and meet or interview options such as “Meet Now” 1126 “Meet Later” 1128, “Maybe” 1130 and “Not Interested” 1132, it will be understood that embodiments may involve other numbers of candidates 125, and candidate data and/or meet or interview options may be displayed together with one or multiple types of location and distance data 1120 and/or 1122 to provide employers 315 with location information to assess which candidates 325 are within a desired geographic area relative to the employer 315.

Further, while certain embodiments are described above with reference to an interface 1100 having a certain sequence of screens, some of which may be accessed by the navigation menu 1138, it will be understood that the employer 315 can navigate back and forth and in different screens and in different via the navigation menu 138 to create a new job 1138a, view search results or status 1138a of candidates 135, view messages 1138c received from and/.or sent to candidates 325 to approach a candidate 325 or in response to a candidate invitation.

For example, as shown in FIG. 11M, an employer 315 can enter or update settings via the menu bar 1138 and enter or update contact information 1142 (e.g., phone number or e-mail address), profile data e.g., qualifications, job titles, experience, etc.), and reset data 1144 such as a password.

Further, while not illustrated in FIG. 11M, but as described above with reference to FIG. 6M, the employer 315 can add a photo to the profile 318 so that when the candidate 325 and employer 315 meet in response to a candidate invitation, the candidate 325 will know what the employer 315 looks like, which may be particularly beneficial if the candidate 325 and employer 315 are meeting at a location with a large number of people. Moreover, it will be understood that it may not be necessary to display all of the screens shown in FIGS. 6A-M. For example, certain screens such as profile creation screens and contact information screens may be necessary for first time users such that after that data is entered, those screens are not displayed, but the data may still be updated or revised by clicking on the “status” menu to access and update the data as needed.

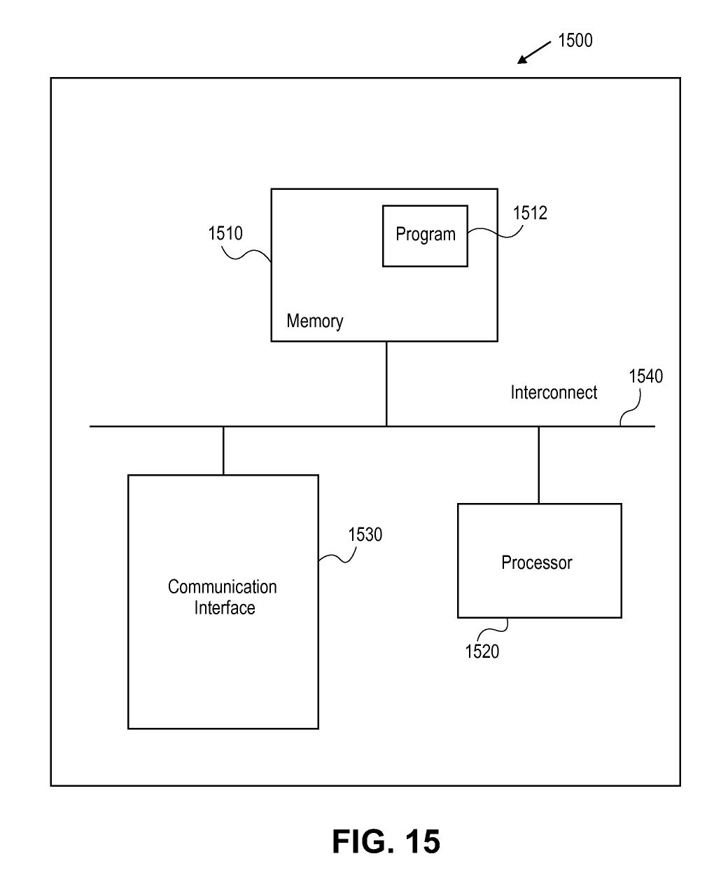

FIG. 15 generally illustrates components of a computing apparatus 1500 that may be included in or utilized by one or more computers or mobile communication devices. Such computing or mobile communication devices may be, or include or utilize, a personal computer system, a desktop computer, a laptop or notebook computer, a mainframe computer system, a handheld computer, a workstation, a network computer, a consumer device, a mobile or cellular phone, a personal digital assistant (PDA), a smartphone, a PDA phone, a two-way paging device, an application server, a storage device, a peripheral device such as a switch, modem, router, or other suitable computing or communications device.

Components of a computing device 1500 includes a memory 1510, program instructions 1512, a processor or controller 1520, a network or communications interface 1530, and connections or interconnect 1540 between such components. For example, the memory 1510 may be or include one or more of cache, RAM, ROM, SRAM, DRAM, RDRAM, EEPROM and other types of memory. The processor unit 1520 may be or include multiple processors, a single threaded processor, a multi-threaded processor, a multi-core processor, or other type of processor. Depending on the particular system component (e.g., whether the component is a computer or a hand held mobile communications device), the interconnect 1540 may include a system bus, LDT, PCI, ISA, or other types of buses, and the communications or network interface may, for example, be an Ethernet interface, a Frame Relay interface, or other interface. The network interface 1530 may be configured to enable a system component to communicate with other system components across a network which, as explained above, may be a wireless or various other networks. It is understood that any component of system 1500 may be located remotely and accessed via a network. Accordingly, the system configuration provided in FIG. 15 is provided for ease of explanation and illustration to generally illustrate system components that may be utilized in various embodiments.

Method embodiments may also be embodied in, or readable from, a computer-readable medium or carrier, e.g., one or more of the fixed and/or removable data storage data devices and/or data communications devices connected to a computer. Carriers may be, for example, magnetic storage medium, optical storage medium and magnetooptical storage medium. Examples of carriers include, but are not limited to, a floppy diskette, a memory stick or a flash drive, CD-R, CD-RW, CD-ROM, DVD-R, and DVD-RW, or other carrier capable of retaining computer readable information. The processor 1520 performs steps or executes program instructions 1512 within memory 1510 and/or embodied on the carrier to implement method embodiments.

Although particular embodiments have been shown and described, it should be understood that the above discussion is not intended to limit the scope of these embodiments. While embodiments and variations of the many aspects of the invention have been disclosed and described herein, such disclosure is provided for purposes of explanation and illustration only. Thus, various changes and modifications may be made without departing from the scope of the claims.

For example, while certain embodiments are described with interfaces displayed to employers and candidates that are similar or the same, embodiments may be implemented with different interfaces and sequences and numbers of screens presented. Thus, the screens, and number and sequence thereof described above, are provided to illustrate one manner in which embodiments may be implemented.

Further, it will be understood that an employer or candidate selecting a meeting or interest option such as “Meet Now,” Meet Later,” “Interested,” “Maybe” and “Not Interested” may be selected during the first time using the application, during the first time an employer or candidate profile is reviewed, to schedule a meeting or interview, to express a level of interest, or as a response to an invitation. Thus, while certain embodiments are described with reference to an action (e.g., invitation to meet now or meet later) initiated by a candidate or by an employer, those actions may also be in response to a message received and thus accepting an invitation to meet now or meet later.

Moreover, it will be understood that while certain embodiments are described with reference to a bartender as an example job category, embodiments may involve additional other numbers of employers, candidates and employment opportunities of various types so that embodiments may be used by tens, hundreds, thousands and other numbers of employers and candidates for various types and numbers of employment categories.

It will also be understood that the matching criteria utilized may involve an employer or candidate seeking an exact match, match of one or more particular attributes, or matching of a pre-determined number of attributes. For purposes of comparison, the types of data compared can be the same, and in the event that there are different labels, the application can map sections of employer and candidate profiles to each other and then compare corresponding data.

Further, it will be understood that while initial communications, e.g., an initial invitation or expression of interest, is directed through the intermediate computer or “in system” subsequent communications may involve “in system” communications or “out of system” communications in which employers and candidates communicate with each other directly after receiving personal contact information, e.g., via phone, e-mail or text or SMS messaging.

It should also be understood that the profile engine may perform comparisons for exact matches or the profile engine may be configured to account for some variance, e.g., a 10% variance for numerical data such as number of years of experience.

Further aspects of embodiments are also described in U.S. Provisional Application Ser. No. 61/509,437, the contents of which were previously incorporated herein by reference, and which provides examples of involvement of employees and employers in location-based, mobile-to-mobile employment or candidate searches, and examples involving matching criteria of 75%. Appendix A of the incorporated provisional application also illustrates embodiments in which candidate locations and/or job locations are mapped, connections to FACEBOOK pages, and “meet now” invitations.

While multiple embodiments and variations of the many aspects of the invention have been disclosed and described herein, such disclosure is provided for purposes of illustration only. Where methods and steps described above indicate certain events occurring in certain order, those of ordinary skill in the art having the benefit of this disclosure would recognize that the ordering of certain steps may be modified to be performed in different orders and/or in concurrently, and that such modifications are in accordance with the variations of the invention. Thus, the methods shown in various flow diagrams are not intended to be limited to a particular sequential order, particularly in instances in which certain steps may or may not be performed or may be performed simultaneously. Accordingly, embodiments are intended to exemplify alternatives, modifications, and equivalents that may fall within the scope of the claims.

What is claimed is:

1. A computer-implemented, location-based method for connecting an employer and a candidate employee, the method comprising:
displaying, on a first mobile communication device of the candidate employee, data of a first employment opportunity offered by a first employer together with at least one of a first distance between a current location of the first mobile communication device and a current location of a second mobile communication device of the first employer, and a second distance between a location of the first employment opportunity and a location of a residence of the candidate employee;
receiving a first input entered by the candidate employee into the first mobile communication device and indicating whether the candidate employee wants to meet with the first employer regarding the first employment opportunity; and
sending a first electronic message from the first mobile communication device to the second mobile communication device based at least in part upon the first input.

2. The method of claim 1, before displaying the first employment opportunity data, the method further comprising:
receiving a profile entered or selected by the candidate employee using the first mobile communication device; and
transmitting the candidate employee profile from the first mobile communication device to an intermediate computer hosting a database comprising a plurality of employer profiles, wherein the first employer profile is selected from the plurality of employer profiles based at least in part upon the intermediate computer comparing the candidate employee profile and the plurality of employer profiles, the selected first employer profile comprising the first employment opportunity being sent from the intermediate computer to the first mobile communication device to be displayed on the first mobile communication device of the candidate employee.

3. The method of claim 1, before displaying the first employment opportunity data, the method further comprising:
receiving location criteria selected or entered by the candidate employee utilizing the first mobile communication device, the location criteria comprising a pre-determined distance from the current location of the first mobile communication device or from a zip code selected or entered by the candidate employee,
receiving a profile entered or selected by the candidate employee using the first mobile communication device; and
transmitting the location criteria and the candidate employee profile from the first mobile communication device to the intermediate computer, wherein the first employer profile is selected from the plurality of employer profiles based at least in part upon a location of the first employment opportunity satisfying the location criteria and the intermediate computer comparing the candidate employee profile and the plurality of employer profiles.

4. The method of claim 1, further comprising accessing or receiving global positioning system data of respective first and second mobile communication devices indicating respective current locations of respective first and second mobile communication devices.

5. The method of claim 1, the first electronic message being sent to the second mobile communication device through an intermediate computer hosting a database comprising data of the candidate employee, the first employer and the first employment opportunity.

6. The method of claim 5, the current location of the second mobile communication device being received at the first mobile communication device through the intermediate computer.

7. The method of claim 1, the first electronic message scheduling for an interview with the first employer in real time and inviting the first employer to meet the candidate employee immediately.

8. The method of claim 1, the first electronic message scheduling an interview with the first employer in real time and inviting the first employer to meet the candidate employee on a later scheduled date or at a scheduled later time.

9. The method of claim 1, the first electronic message comprising contact information of the candidate employee that can be viewed by the employer on the second mobile communication device.

10. The method of claim 1, further comprising receiving a second electronic message at the first mobile communication device and sent from the second mobile communication device, the second electronic message being sent by the employer in response to the first electronic message and comprising contact information of the employer that can be viewed by the candidate employee on the first mobile communication device.

11. The method of claim 10, the second electronic message being sent to the first mobile communication device through an intermediate computer hosting a database comprising data of the candidate employee, the first employer and the first employment opportunity.

12. The method of claim 1, the first input indicating that the first candidate employee is not interested in the first employment opportunity, the method further comprising sending a second electronic message from the first mobile communication device to an intermediate computer hosting a database comprising data of the candidate employee, the employer and the employment opportunity, the second electronic message indicating that employment opportunities offered by the employer should not be displayed to the candidate employee.

13. The method of claim 1, the first electronic message proposing an interview with the first employer, the method further comprising
receiving a second electronic message from the first employer agreeing with a meeting location proposed by the candidate employee or proposing the meeting location;
generating a map showing a route from the current location of the first mobile communication device to the meeting location; and
displaying the map showing the route on the first mobile communication device to the candidate employee.

14. The method of claim 13, further comprising
receiving a photograph of the employer at the first mobile communication device of the candidate employee, and
displaying the photograph on the first mobile communication device to the candidate employee.

15. The method of claim 1, wherein the first distance and the second distance are both displayed.

16. The method of claim 15, the first distance and the second distance being concurrently displayed in a single screen view on the first mobile communication device.

17. The method of claim 1, further comprising
displaying, on the first mobile communication device, data of a second employment opportunity offered by a second employer together with at least one of a third distance between a current location of the first mobile communication device and a current location of a third mobile communication device of the second employer, and a fourth distance between a location of the second employment opportunity and the location of the residence of the candidate employee;
receiving a second input entered by the candidate employee into the first mobile communication device and indicating whether the candidate employee wants to meet with the second employer regarding the second employment opportunity; and
sending a second electronic message from the first mobile communication device to the third mobile communication device based at least in part upon the second input.

18. The method of claim 17, wherein the third distance and the fourth distance are both displayed.

19. The method of claim 18, the third distance and the fourth distance being concurrently displayed in a single screen view on the first mobile communication device.

20. The method of claim 1, the first employment opportunity being displayed on the first mobile communication device if the at least one of the first distance is less than a first pre-determined distance, and the second distance is less than a second pre-determined distance.

21. A computer-implemented, location-based method for connecting an employer and a candidate employee, the method comprising:
displaying, on a first mobile communication device of an employer, data of a first candidate employee for an employment opportunity offered by the employer together with at least one of: a first distance between a current location of the first mobile communication device and a current location of a second mobile communication device of the first candidate employee, and a second distance between a location of the employment opportunity and a location of a residence of the first candidate employee;
receiving a first input entered by the employer into the first mobile communication device and indicating whether the employer wants to meet with the first candidate employee regarding the employment opportunity; and
sending a first electronic message from the first mobile communication device to the second mobile communication device based at least in part upon the first input.

22. The method of claim 21, before displaying the first candidate employee data, the method further comprising:
receiving a profile entered or selected by the employer using the first mobile communication device; and
transmitting the employer profile from the first mobile communication device to an intermediate computer hosting a database comprising a plurality of candidate employee profiles, wherein the first candidate employee profile is selected from the plurality of candidate employee profiles based at least in part upon the intermediate computer comparing the employer profile and the plurality of candidate employee profiles, the selected first candidate employee profile being sent from the intermediate computer to the first mobile communication device to be displayed on the first mobile communication device to the employer.

23. The method of claim 22, before displaying the first candidate employee data, the method further comprising:
receiving location criteria selected or entered by the employer utilizing the first mobile communication device, the location criteria comprising a pre-determined distance from the current location of the first mobile communication device or from a zip code selected or entered by the employer,
receiving a profile entered or selected by the employer using the first mobile communication device; and
transmitting the location criteria and the employer profile from the first mobile communication device to the intermediate computer, wherein the first candidate employee profile is selected from the plurality of candidate employee profiles based at least in part upon a location of the first candidate employee satisfying the location criteria and the intermediate computer comparing the employer profile and the plurality of candidate employee profiles.

24. The method of claim 21, further comprising accessing or receiving global positioning system data of respective first and second mobile communication devices indicating respective current locations of respective first and second mobile communication devices.

25. The method of claim 21, the first electronic message being sent to the second mobile communication device through an intermediate computer hosting a database comprising data of the employer, the first candidate employee and the employment opportunity.

26. The method of claim 25, the current location of the second mobile communication device being received at the first mobile communication device through the intermediate computer.

27. The method of claim 21, the first electronic message scheduling for an interview with the first candidate employee in real time and inviting the first candidate employee to meet the employer immediately.

28. The method of claim 21, the first electronic message scheduling an interview with the first candidate employee in real time and inviting the first candidate employee to meet the employer on a later scheduled date or at a scheduled later time.

29. The method of claim 21, the first electronic message comprising contact information of the employer that can be viewed by the first candidate employee on the second mobile communication device.

30. The method of claim 21, further comprising receiving a second electronic message at the first mobile communication device and sent from the second mobile communication device, the second electronic message being sent by the first candidate employee in response to the first electronic message and comprising contact information of the first candidate employee that can be viewed by the employer on the first mobile communication device.

31. The method of claim 30, the second electronic message being sent to the first mobile communication device through an intermediate computer hosting a database comprising data of the employer, the first candidate employee, and the first employment opportunity.

32. The method of claim 21, the first input indicating that the employer is not interested in the first candidate employee, the method further comprising sending a second electronic message from the first mobile communication device to an intermediate computer hosting a database comprising data of the employer, the first candidate employee, and the employment opportunity, the second electronic message indicating that candidate employee should not be displayed to the employer.

33. The method of claim 21, the first electronic message proposing an interview with the first candidate employee, the method further comprising:
receiving a second electronic message from the first candidate employee agreeing with a meeting location proposed by the employer or proposing the meeting location;
generating a map showing a route from the current location of the first mobile communication device to the meeting location; and
displaying the map showing the route on the first mobile communication device to the employer.

34. The method of claim 33, further comprising:
receiving a photograph of the first candidate employee at the first mobile communication device of the employer, and
displaying the photograph on the first mobile communication device to the employer.

35. The method of claim 21, the first distance and the second distance being concurrently displayed in a single screen view on the first mobile communication device.

36. The method of claim 1, further comprising
displaying, on the first mobile communication device, data of a second candidate employee for the employment opportunity together with at least one of: a third distance between the current location of the first mobile communication device and a current location of a third mobile communication device of the second candidate employee, and a fourth distance between a location of the employment opportunity and the location of the residence of the first candidate employee;
receiving a second input entered by the employer into the first mobile communication device and indicating whether the employer wants to meet with the second candidate employee regarding the employment opportunity; and
sending a second electronic message from the first mobile communication device to the third mobile communication device based at least in part upon the second input.

37. The method of claim 36, wherein the third distance and the fourth distance are both displayed.

38. The method of claim 37, the third distance and the fourth distance being concurrently displayed in a single screen view on the first mobile communication device.

39. A computer program product or mobile application comprising a non-transitory, computer readable storage medium having a sequence of instructions which, when executed by a mobile communication device, cause the one or more processors to execute a process for location-based mobile-to-mobile matching an employer with a candidate employee, the process comprising displaying, on a first mobile communication device of the candidate employee, data of a first employment opportunity offered by a first employer together with at least one of a first distance between a current location of the first mobile communication device and a current location of a second mobile communication device of the first employer, and a second distance between a location of the employment opportunity and a location of a residence of the candidate employee, receiving a first input entered by the candidate employee into the first mobile communication device and indicating whether the candidate employee wants to meet with the first employer regarding the first employment opportunity, and sending a first electronic message from the first mobile communication device to the second mobile communication device based at least in part upon the first input.

40. A computer program product or mobile application comprising a non-transitory, computer readable storage medium having a sequence of instructions which, when executed by a mobile communication device, cause the one or more processors to execute a process for location-based mobile-to-mobile matching an employer with a candidate employee, the process comprising displaying, on a first mobile communication device of an employer, data of a first candidate employee for an employment opportunity offered by the employer together with at least one of a first distance between a current location of the first mobile communication device and a current location of a second mobile communication device of the candidate employee, and a second distance between a location of the employment opportunity and a location of a residence of the candidate employee, receiving a first input entered by the employer into the first mobile communication device and indicating whether the employer wants to meet with the first candidate employee regarding the employment opportunity, sending a first electronic message from the first mobile communication device to the second mobile communication device based at least in part upon the first input.
